(19) United States
(12) Patent Application Publication
(10) Pub. No.: US 2026/0189537 A1
(43) Pub. Date: Jul. 2, 2026

(54) SYSTEMS AND METHODS FOR SECURE ONLINE ACTIVITIES TO ENHANCE DATA SECURITY AND EFFICIENCY

(71) Applicant: The PNC Financial Services Group, Inc., Pittsburgh, PA (US)

(72) Inventors: Robert Peter Sandt, Jr., Park Ridge, NJ (US); Jared John Grunig, Chanhassen, MN (US)

(73) Assignee: The PNC Financial Services Group, Inc., Pittsburgh, PA (US)

(21) Appl. No.: 19/225,833

(22) Filed: Jun. 2, 2025

Related U.S. Application Data
(60) Provisional application No. 63/739,876, filed on Dec. 30, 2024.

(51) Int. Cl. H04L 9/40; H04L 51/224

(52) U.S. Cl. CPC H04L 63/0428; H04L 51/224

(57) ABSTRACT

A method for enhancing data security and data transmission efficiency for online activities, the method comprising: receiving a data set for the plurality of parties; determining an activity instruction based on the received data set; storing data from the data set and the activity instruction in a directory; sending, upon notification authorization, an alert notification to the counterparty about the activity instruction; receiving an additional data set for the counterparty; determining an additional activity instruction based on the received additional data set; storing data from the additional data set and the additional activity instruction in the directory; modifying the activity instruction by integrating the additional activity instruction; receiving an activity authorization associated with the activity identifier; determining an activity permission associated with the activity identifier; and initiating an electronic resource distribution protocol based on the modified activity instruction.

### CROSS REFERENCE TO RELATED APPLICATION

This application claims the benefit of priority of United States Provisional Patent Application No. 63/739,876, filed on December 30, 2024, the entire contents of which are incorporated herein by reference.

### TECHNICAL FIELD

The present disclosure generally relates to systems and methods for secure online activities and, more particularly, to systems and methods for secure online activities to enhance data security and efficiency.

### BACKGROUND

A conventional method of handling online activities, such as handling escrow agreements and claim requests digitally, largely relies on email-based communication between parties involved in such activities. For example, the parties engaging in a financial transaction online frequently exchange critical documents containing transaction-related information via email. This method of using email is often used due to its accessibility, simplicity, and the ability to send documents quickly. However, several challenges and risks exist when using emails for handling online activities, especially for activities involving sensitive information.

There may be security concerns when sensitive information is exchanged via email communication. For example, unless properly encrypted, the communication may be exposed to interception, unauthorized access, or fraud by malicious actors. There may also be document integrity issues because verification of documents shared via email may be difficult. Without secure digital signatures or other forms of authentication technology, it may be challenging to ensure the documents have not been tampered with.

Another concern with the current practice of handling online activities via email communication is inefficiency. Managing the flow of documents through email may be cumbersome, particularly when multiple parties are involved. It may be difficult to keep track of all documents exchanged in an online activity and it takes time to review and organize the documents to ensure compliance with the terms of the activity. When an audit is needed for a past online activity, it may take significant time to collect, organize, and review all the documents scattered throughout multiple emails related to the activity. Additionally, email communication requires a greater memory allocation of participating parties’ storage systems, apart from server-side memory, to store, send, and process voluminous data when handling online activities.

In light of these risks and challenges, there is a need to provide a more secure and efficient system to handle sensitive online activities, such as escrow agreements and claim requests (i.e., formal requests for payment or capital in financial transactions). Accordingly, it is desirable to develop systems and methods for secure online activities to enhance data security and efficiency.

### SUMMARY

Embodiments of the present disclosure may provide a method for enhancing data security and data transmission efficiency for online activities. The method may comprise providing for display, on a graphical user interface: at least one first section, wherein each first section is associated with an online activity identifier, and a plurality of second sections, wherein each second section is associated with one of an activity data set. The method may further comprise receiving a data set for a plurality of parties, wherein the data set includes, for each of the plurality of parties, at least one of: a party identifier, an activity identifier associated with a party, a counterparty identifier, an activity source account identifier, a beneficiary account identifier, a party authorized signatory, or distribution parameters. The method may further comprise determining, for each of the plurality of parties, an activity instruction based on the received data set. The method may further comprise storing data from the data set and the activity instruction in a directory. The method may further comprise sending, upon a notification authorization, an alert notification to a counterparty about the activity instruction. The method may further comprise receiving an additional data set for the counterparty, wherein the additional data set includes at least one of: a counterparty identifier, a counterparty authorized signatory, or changes to the distribution parameters. The method may further comprise determining an additional activity instruction based on the received additional data set. The method may further comprise storing data from the additional data set and the additional activity instruction in the directory. The method may further comprise modifying the activity instruction by integrating the additional activity instruction. The method may further comprise receiving, for each activity identifier, an activity authorization associated with the activity identifier. The method may further comprise determining, for each activity identifier, an activity permission associated with the activity identifier. The method may further comprise initiating an electronic resource distribution protocol based on the modified activity instruction.

According to an embodiment of the present disclosure, the method may further comprise displaying a plurality of lists, on a graphical user interface, the plurality of lists associated with at least one of: a party identifier, an activity identifier associated with a party, a counterparty identifier, an activity source account identifier, a beneficiary account identifier, a party authorized signatory, a counterparty signatory, distribution parameters, or any combination thereof.

According to an embodiment of the present disclosure, the method may further comprise automatically populating an activity instruction based on a previously received data set.

According to an embodiment of the present disclosure, automatically populated activity instruction may be based on at least one of: a party identifier, an activity identifier associated with a party, a counterparty identifier, an activity source account identifier, a beneficiary account identifier, a party authorized signatory, a counterparty signatory or distribution parameters.

According to an embodiment of the present disclosure, the method may further comprise modifying the automatically populated activity instruction when the party overwrites a data element in the previously received data set.

According to an embodiment of the present disclosure, the method may further comprise providing for display, on a graphical user interface, at least one file upload page or modal for the plurality of parties. The method may further comprise receiving external files, wherein the external files are associated with the data set for the plurality of parties. The method may further comprise storing the external files in the directory.

According to an embodiment of the present disclosure, the method may further comprise providing for display, on a graphical user interface, at least one file upload page or modal for the counterparty. The method may further comprise receiving external files, wherein the external files are associated with the additional data set for the counterparty. The method may further comprise storing the external files in the directory.

According to an embodiment of the present disclosure, the notification authorization may be initially set to not authorized status.

According to an embodiment of the present disclosure, the method may further comprise updating the notification to authorized status.

According to an embodiment of the present disclosure, the alert notification may be delivered via at least one of a short message service text notification, an application push notification, an email notification, or any combination thereof.

According to an embodiment of the present disclosure, the method may further comprise providing for display, on a graphical user interface, a confirmation page or modal. The method may further comprise displaying the received data set associated with activity identifier and source account data. The method may further comprise receiving, via the confirmation page or modal, the party input to modify the data set or to confirm the data set to be proper.

According to an embodiment of the present disclosure, the method may further comprise providing for display, on a graphical user interface, a confirmation page or modal. The method may further comprise displaying the received data set associated with activity identifier, a first value amount and reference instructions data. The method may further comprise receiving, via the confirmation page or modal, the party input to modify the data set or to confirm the data set to be proper.

According to an embodiment of the present disclosure, the method may further comprise providing for display, on a graphical user interface, a confirmation page or modal. The method may further comprise displaying the received data set associated with activity identifier and transfer instructions data. The method may further comprise receiving, via the confirmation page or modal, the party input to modify the data set or to confirm the data set to be proper.

According to an embodiment of the present disclosure, the transfer instructions data include transfer method options.

According to an embodiment of the present disclosure, the method may further comprise providing for display, on a graphical user interface, a confirmation page or modal. The method may further comprise displaying the received data set associated with activity identifier and party authorized signatory data. The method may further comprise receiving, via the confirmation page or modal, the party input to modify the data set or to confirm the data set to be proper.

According to an embodiment of the present disclosure, the method may further comprise providing for display, on a graphical user interface, a confirmation page. The method may further comprise displaying the summary of received data set associated the activity instruction. The method may further comprise receiving, via the confirmation page, the party input to modify the data set or to submit the data set.

According to an embodiment of the present disclosure, determining the activity permission based on the activity authorization, the activity instruction, the data set and the additional data set may further comprise setting the activity permission to permitted if there is no missing requisite data.

According to an embodiment of the present disclosure, the method may further comprise blocking a certain value amount from the electronic resource distribution protocol if an unresolved claim associated with the source account identifier exists prior to the electronic resource distribution protocol.

Embodiments of the present disclosure may provide a non-transitory computer readable medium storing instructions that, when executed by at least one processor, cause the at least one processor to perform operations for enhancing data security and data transmission efficiency for secure online activities. The operations may comprise providing for display, on a graphical user interface: at least one first section, wherein each first section is associated with an online activity identifier and a plurality of second sections, wherein each second section is associated with one of an activity data set. The operations may further comprise receiving a data set for a plurality of parties, wherein the data set includes, for each of the plurality of parties, at least one of: a party identifier, an activity identifier associated with a party, a counterparty identifier, an activity source account identifier, a beneficiary account identifier, a party authorized signatory, or distribution parameters. The operations may further comprise determining, for each of the plurality of parties, an activity instruction based on the received data set. The operations may further comprise storing data from the data set and the activity instruction in a directory. The operations may further comprise sending, upon a notification authorization, an alert notification to a counterparty about the activity instruction. The operations may further comprise receiving an additional data set for the counterparty, wherein the additional data set includes at least one of: a counterparty identifier, a counterparty authorized signatory, or changes to the distribution parameters. The operations may further comprise determining an additional activity instruction based on the received additional data set. The operations may further comprise storing data from the additional date set and the additional activity instruction in the directory. The operations may further comprise modifying the activity instruction by integrating the additional activity instruction. The operations may further comprise receiving, for each activity identifier, an activity authorization associated with the activity identifier. The operations may further comprise determining, for each activity identifier, an activity permission associated with the activity identifier. The operations may further comprise initiating an electronic resource distribution protocol based on the modified activity instruction. Embodiments of the present disclosure may provide a system for enhancing data security and data transmission efficiency for secure online activities. The system may comprise a memory storing instructions and at least one processor configured to execute the instructions. The instructions may include providing for display, on a graphical user interface at least one first section, wherein each first section is associated with an online activity identifier and a plurality of second sections, wherein each second section is associated with one of an activity data set. The instructions may further include receiving a data set for a plurality of parties, wherein the data set includes, for each of the plurality of parties, at least one of: a party identifier, an activity identifier associated with a party, a counterparty identifier, an activity source account identifier, a beneficiary account identifier, a party authorized signatory, or distribution parameters. The instructions may further include determining, for each of the plurality of parties, an activity instruction based on the received data set. The instructions may further include storing data from the data set and the activity instruction in a directory. The instructions may further include sending, upon a notification authorization, an alert notification to a counterparty about the activity instruction. The instructions may further include receiving an additional data set for the counterparty, wherein the additional data set includes at least one of: a counterparty identifier, a counterparty authorized signatory, or changes to the distribution parameters. The instructions may further include determining an additional activity instruction based on the received additional data set. The instructions may further include storing data from the additional date set and the additional activity instruction in the directory. The instructions may further include modifying the activity instruction by integrating the additional activity instruction. The instructions may further include receiving, for each activity identifier, an activity authorization associated with the activity identifier. The instructions may further include determining, for each activity identifier, an activity permission associated with the activity identifier. The instructions may further include initiating an electronic resource distribution protocol based on the modified activity instruction.

The methods and systems disclosed herein may be used in various applications and business systems. It is to be understood that the foregoing general description and the following detailed description are exemplary and explanatory only and are not restrictive of the disclosed embodiments.

### BRIEF DESCRIPTION OF THE DRAWINGS

The accompanying drawings, which are incorporated in and constitute a part of this specification, illustrate disclosed embodiments and, together with the description, serve to explain the disclosed embodiments.

FIG. 1A is a block diagram illustrating an exemplary application of an online activity system, consistent with conventional method of handling activities online.

FIG. 1B is a block diagram illustrating an exemplary application of a secure online activity system, consistent with disclosed embodiments.

FIG. 2A is a block diagram illustrating an exemplary secure online activity system, consistent with disclosed embodiments.

FIG. 2B is a block diagram illustrating an exemplary party or counterparty computing device, consistent with disclosed embodiments.

FIG. 3 is a flow diagram illustrating an exemplary method for a secure online activity, consistent with disclosed embodiments.

FIG. 4A is an exemplary display on a graphical user interface displaying an overview of a secure online activity to a party in the activity, consistent with disclosed embodiments.

FIG. 4B is an exemplary display on a graphical user interface wherein a secure online activity is edited by a party in the activity, consistent with disclosed embodiments.

FIG. 5A is an exemplary display on a graphical user interface displaying available documents for a party involved in a secure online activity, consistent with disclosed embodiments.

FIG. 5B is an exemplary display on a graphical user interface illustrating a party involved in a secure online activity uploading new documents, consistent with disclosed embodiments.

FIG. 6A is an exemplary display on a graphical user interface illustrating initiation of a secure online activity, consistent with disclosed embodiments.

FIG. 6B is an exemplary display on a graphical user interface wherein a list item, from the list of secure online activities that may be initiated, is expanded, consistent with disclosed embodiments.

FIG. 6C is an exemplary display on a graphical user interface wherein a list item, from the list of secure online activities that may be initiated, is further expanded, consistent with disclosed embodiments.

FIG. 7 is an exemplary display on a graphical user interface of selecting an activity instruction, consistent with disclosed embodiments.

FIG. 8 is an exemplary display on a graphical user interface illustrating selection of an activity identifier to set up an activity instruction, consistent with disclosed embodiments.

FIG. 9A is an exemplary display on a graphical user interface illustrating selecting participants in a secure online activity to set up an activity instruction, consistent with disclosed embodiments.

FIG. 9B is an exemplary display on a graphical user interface of displaying selected participants in a secure online activity for an activity instruction, consistent with disclosed embodiments.

FIG. 10A is an exemplary display on a graphical user interface illustrating selecting a source account with missing information for an activity instruction, consistent with disclosed embodiments.

FIG. 10B is an exemplary display on a graphical user interface illustrating selecting a source account for an activity instruction, consistent with disclosed embodiments.

FIG. 11A is an exemplary display on a graphical user interface of resolving claim holds with a source account, consistent with disclosed embodiments.

FIG. 11B is an exemplary display on a graphical user interface presenting methods of claim hold resolution, consistent with disclosed embodiments.

FIG. 12 is an exemplary display on a graphical user interface of setting up an activity instruction by adding distribution information, consistent with disclosed embodiments.

FIG. 13 is an exemplary display on a graphical user interface showing a confirmation message about the proper setup of an activity identifier and a source account, consistent with disclosed embodiments.

FIG. 14A is an exemplary display on a graphical user interface illustrating setting up an activity instruction by adding a value amount and reference instructions, consistent with disclosed embodiments.

FIG. 14B is an exemplary display on a graphical user interface illustrating setting up an activity instruction by uploading documents regarding value amount and reference instructions, consistent with disclosed embodiments.

FIG. 15 is an exemplary display on a graphical user interface showing a confirmation message about the proper setup of a value amount and reference instructions, consistent with disclosed embodiments.

FIG. 16A is an exemplary display on a graphical user interface illustrating setting up an activity instruction by establishing transfer instructions, consistent with disclosed embodiments.

FIG. 16B is an exemplary display on a graphical user interface illustrating setting up an activity instruction by adding required information for a selected transfer method, consistent with disclosed embodiments.

FIG. 16C is an exemplary display on a graphical user interface of setting up an activity instruction by adding required information for a selected transfer method, consistent with disclosed embodiments.

FIG. 16D is an exemplary display on a graphical user interface illustrating setting up an activity instruction by adding required information once a transfer method is selected, consistent with disclosed embodiments.

FIG. 17 is an exemplary display on a graphical user interface showing a confirmation message about the proper setup of transfer instructions, consistent with disclosed embodiments.

FIG. 18 is an exemplary display on a graphical user interface illustrating setting up an activity instruction by choosing authorized signatories, consistent with disclosed embodiments.

FIG. 19 is an exemplary display on a graphical user interface showing a confirmation message about the proper setup of authorized signatories, consistent with disclosed embodiments.

FIG. 20 is an exemplary display on a graphical user interface for reviewing an activity instruction prior to initiation of a secure online activity, consistent with disclosed embodiments.

### DETAILED DESCRIPTION

Before explaining certain embodiments of the disclosure in detail, it is to be understood that the disclosure is not limited in its application to the details of construction and to the arrangements of the components set forth in the following description or illustrated in the drawings. The disclosure is capable of embodiments in addition to those described and of being practiced and carried out in various ways. Also, it is to be understood that the phraseology and terminology employed herein, as well as in the accompanying drawings, are for the purpose of description and should not be regarded as limiting.

As such, those skilled in the art will appreciate that the conception upon which this disclosure is based may readily be utilized as a basis for designing other structures, methods, and systems for carrying out the several purposes of the present disclosure.

Reference will now be made in detail to the present exemplary embodiments of the invention, examples of which are illustrated in the accompanying drawings. Wherever possible, the same reference numbers will be used throughout the drawings to refer to the same or like parts.

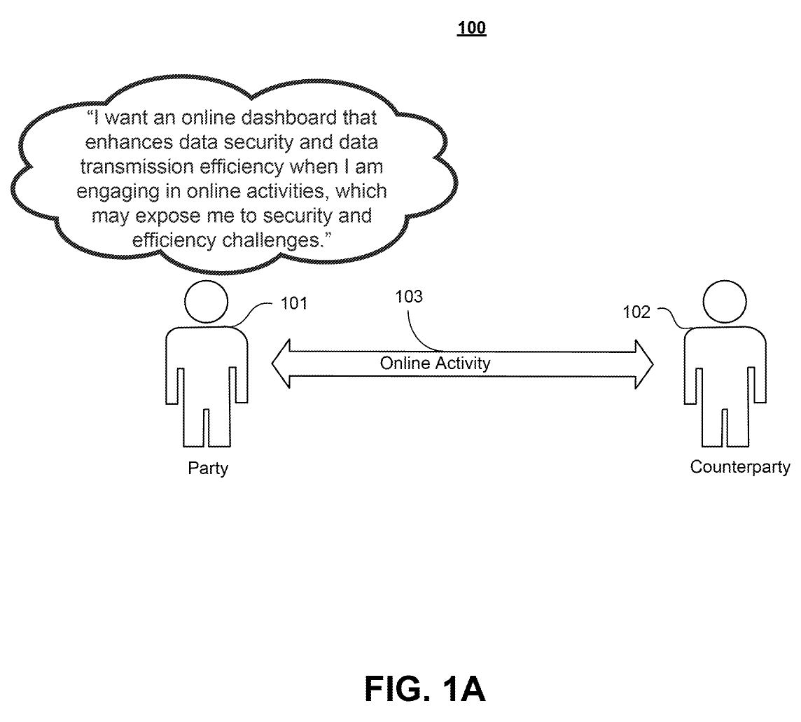

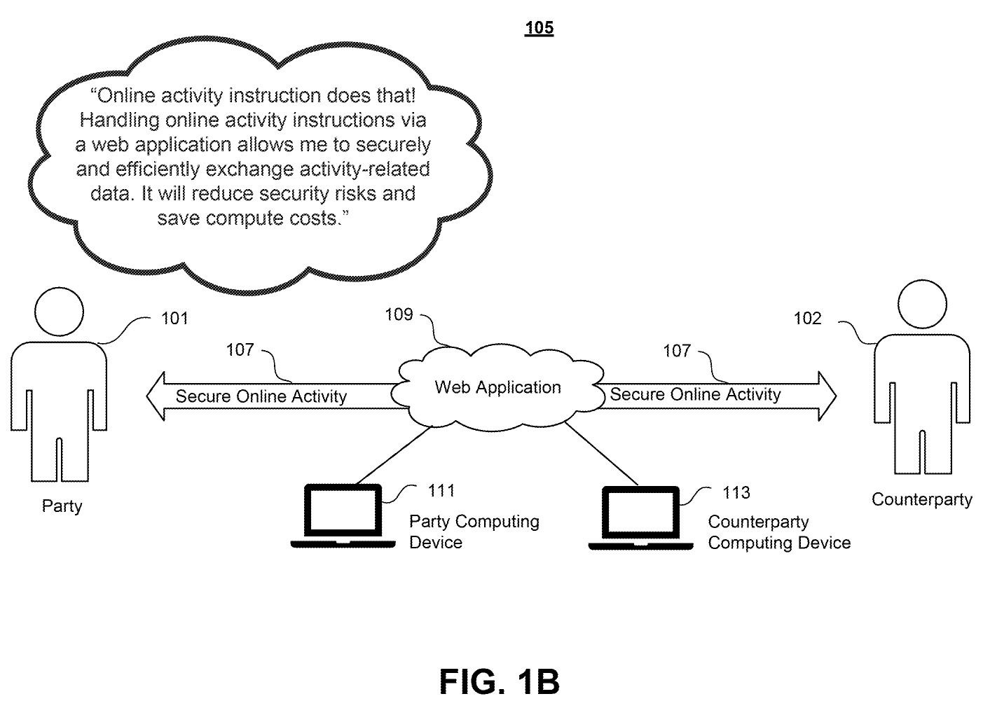

FIG. 1A is a block diagram illustrating a conventional online activity involving a party 101 engaging in a conventional online activity 103 with a counterparty 102. Party 101 or counterparty 102 may include an individual, an organization, or any other entity that may engage in online activities. In some embodiments, a conventional online activity 103 may refer to an online transaction in which parties may exchange transaction-related documents through email or other traditional communication methods. Using a conventional method, party 101 may use email communication with counterparty 102 as the primary tool to exchange relevant transaction-related documents. For example, party 101 may send and/or receive documents such as contracts, identification verifications, signed documents, and other documents containing sensitive activity-related information to counterparty 102 via multiple rounds of emails during engagement of conventional online activity 103. However, reliance on email when handling conventional online activities 103 may expose party 101 to significant security and efficiency challenges. Sensitive information, such as financial details, personal identification data, account information, and other confidential activity-related information are potentially vulnerable to interception or unauthorized access by malicious actors when such sensitive information is sent over email. In addition to malicious actors, such sensitive information may be exposed to unintended third parties due to human error. For example, party 101 may inadvertently send documents to the wrong recipient when party 101 fails to verify the identity of the recipient before sending an email including sensitive information. Moreover, email-based communication is often unstructured and lacks built-in mechanisms for efficiently verifying the status of an activity. For example, there is often no automated way to track whether all required documents have been received, reviewed, or acted upon by the appropriate parties involved in an online activity. As a result, errors in document handling or delays in activity processing may occur, leading to inefficiencies and potential disputes. Although FIG. 1A depicts a single conventional online activity 103 with a single counterparty 102, this is merely exemplary, and party 101 may engage in an online activity with multiple counterparties or may engage in multiple online activities each day. Party 101 may use voluminous amounts of resources and data to secure and track all required documents for each online activity during its pendency. Because of such efforts needed to conduct online activities forward, such as conventional online activity 103, it may be difficult for party 101 to organize, secure, and track online activities. Thus, there is a need for a solution that solves the issues illustrated by FIG. 1A.

FIG. 1B is a simplified block diagram illustrating a situation involving party 101 engaging in an online activity via a web application 109 providing a central platform for secure online activities 107. Web application 109 may be accessed by a party computing device 111 and a counterparty computing device 113. A central platform may refer to any hardware or software hosting a web application infrastructure that allows the application to run. Party computing device 111 or counterparty computing device 113 may be a mobile device, desktop, laptop, tablet, or any other devices capable of accessing web application 109. In some embodiments party 101 and counterparty 102 may engage in secure online activity 107, such as an escrow transaction, through the central platform provided by web application 109 by providing activity instructions (e.g., a joint written instruction, a formal document for escrow that instructs certain escrow activities to occur depending on whether certain escrow conditions have been met, settlement instructions, etc.). Web application 109 may display web pages to facilitate party 101 creating and storing activity-related data including party name, activity name, counterparty name, counterparty contact information, source account information, beneficiary account information, authorized signatory, or electronic resource distribution parameters (e.g., beneficiary name, beneficiary account information, fund distribution amount, payment method, etc.). Web application 109 may alert counterparty 102 identified in the activity instruction about the activity initiated by party 101 via a short message service (SMS) text message, a push notification message on an online banking application, an email, or any combination thereof. Counterparty 102 may provide additional activity-related data (e.g., filling in missing parts of the joint written instructions, updates/changes to information provided by party 101) via web pages provided by web application 109. Web application 109 may provide means for party 101 and/or counterparty 102 to upload documents related to secure online activity 107. Once all of the required data is supplied by party 101 and counterparty 102 via web application 109, electronic resources may be distributed to appropriate parties according to the activity instructions through electronic resource distribution. In some embodiments, an electronic resource distribution may be a fund distribution or payment made from a bank account using an electronic method, such as direct deposit, wire, or ACH. Web application 109 may block a certain value amount from electronic resource distribution if there is an unresolved claim, which has not been fully determined, disputed, or reviewed, between party 101 and counterparty 102 or related to the source account of party 101, and ask party 101 to cancel or resolve the claim. By engaging in online activities via a web application 109, party 101 and counterparty 102 may exchange activity-related information in a more secure and efficient manner. The risk of participants’ information being exposed to malicious actors or unintended third parties may be reduced. Additionally, the inefficiency of exchanging activity-related data over multiple rounds of emails and storing the data in multiple locations may be improved by utilizing a central repository that stores all documents exchanged in an online activity, leading to reduction in computing costs.

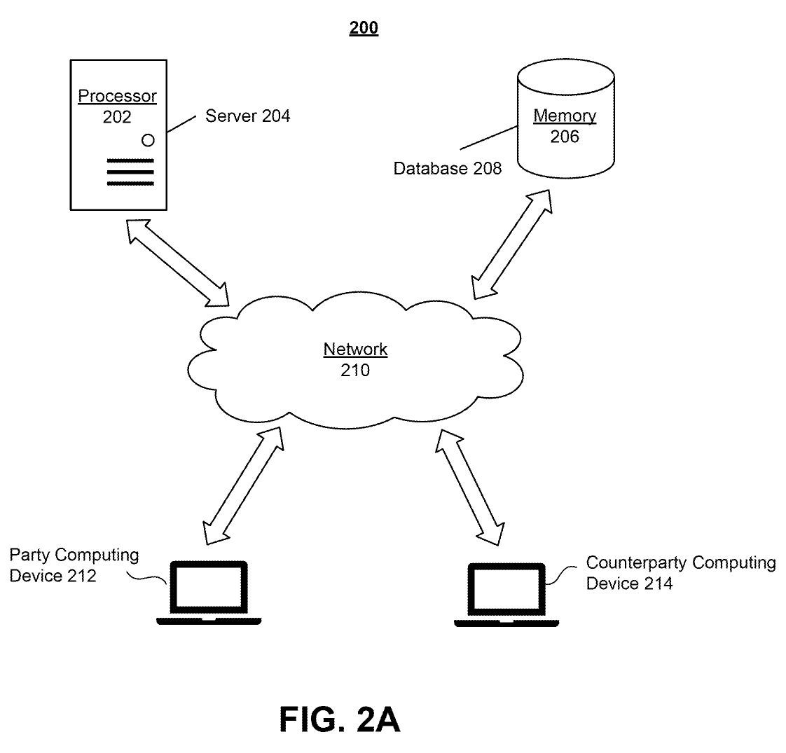

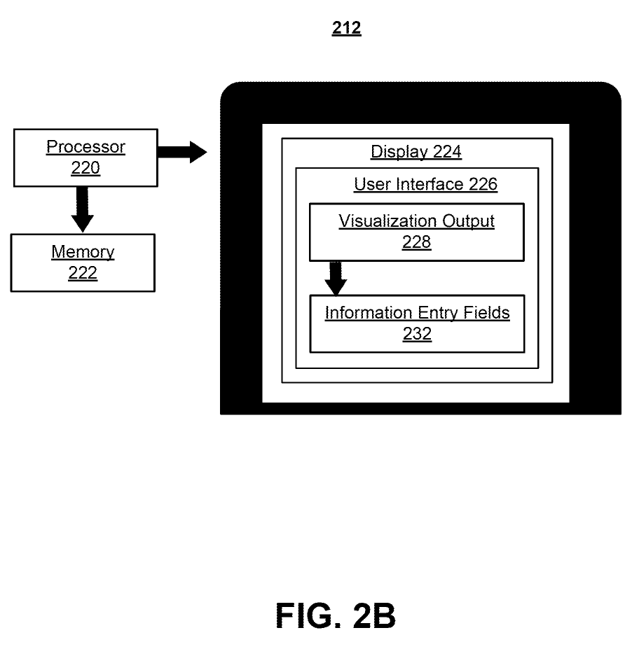

FIG. 2A illustrates an exemplary secure online activity system 200, consistent with disclosed embodiments. Web application 109 may be implemented by system 200. As shown in FIG. 2A, system 200 may include a server 204, which may include at least one processor 202. System 200 may also include a database 208, which may include at least one memory 206. System 200 may also include a network 210, a party computing device 212, and a counterparty computing device 214. Party computing device 212 and counterparty computing device 214 correspond to party computing device 111 and counterparty computing device 113 respectively, as shown in FIG. 1B. In system 200, server 204 and database 208 may communicate with each other via network 210, server 204 and party computing device 212 may communicate with each other over network 210, and party computing device 212 and database 208 may communicate with each other over network 210. Further, counterparty computing device 214 may communicate with party computing device 212, server 204, and database 208 over network 210.

Server 204 may be in communication with network 210. Server 204 may manage the various components in system 200. In some embodiments, server 204 may be configured to process and manage requests between party computing device 212, counterparty computing device 214, and/or databases 208. Server 204 may participate in reconfiguring a plurality of icons on a graphical user interface to optimize memory usage and data transmission efficiency, as disclosed herein.

Consistent with the present disclosure, disclosed embodiments may involve a network (e.g., 210). The network may constitute any type of physical or wireless computer networking arrangement used to exchange data between, for example, computing device 212 or 214, server 204, and/or database 208. For example, the network may be the Internet, a private data network, a virtual private network using a public network, a Wi-Fi network, a LAN or WAN network, a combination of one or more of the foregoing, and/or other suitable connections that may enable information exchange among various components of the system (e.g., 200). In some embodiments, the network may include one or more physical links used to exchange data, such as Ethernet, coaxial cables, twisted pair cables, fiber optics, or any other suitable physical medium for exchanging data. The network may also include a public switched telephone network (“PSTN”) and/or a wireless cellular network. The network may be a secured network or unsecured network. In other embodiments, one or more components of system may communicate directly through a dedicated communication network. Direct communications may use any suitable technologies, including, for example, BLUETOOTH™, BLUETOOTH LE™ (BLE), Wi-Fi, near field communications (NFC), or other suitable communication methods that provide a medium for exchanging data and/or information between for example, computing device 212 and/or 214, server 204, and/or database 208.

FIG. 2B illustrates an exemplary configuration of party computing device 212, consistent with disclosed embodiments. In some embodiments, counterparty computing device 214 may be similarly configured as party computing device 212 depicted in FIG. 2B. Party computing device 212 and, similarly, counterparty computing device 214 may be referred to as party computing device 212 when their similar configuration, components, and features are being described.

As shown in FIG. 2B, party computing device 212 may include at least one processor, such as processor 220. Party computing device 212 may also include memory 222, and processor 220 may be connected to memory 222. Party computing device 212 may also include user interface 226, and processor 220 may control the appearance of user interface 226. In some embodiments, user interface 226 may refer to web pages for a web application. User interface 226 may include information entry fields 232 for receiving user input 230. Processor 220 may receive user input 230 from user interface 226. These inputs may include, for example, activity-related data, uploaded external documents related to a secure online activity, and the party’s indication to authorize an online activity. External documents may include contracts, identification verifications, signed documents, or other sensitive activity-related information in written form. External documents may not exist in system 200 and may be uploaded by party and/or counterparty of the secure online activity. User interface 226 may also contain a visualization output 228. Visualization output 228 may be a display of information to a party/counterparty on a part or section of a web page. Processor 220 may transmit display 224 data to user interface 226, which then may render it on visualization output 228.

Consistent with disclosed embodiments, each of the at least one processors 202 and/or 220 discussed herein and illustrated FIG. 2A and 2B may constitute any physical device or group of devices having electronic circuitry that performs a logic operation on an input or inputs. For example, the processor may include one or more integrated circuits (IC), including an application-specific integrated circuit (ASIC), microchips, microcontrollers, microprocessors, all or part of a central processing unit (CPU), a graphics processing unit (GPU), a digital signal processor (DSP), a field-programmable gate array (FPGA), a server, a virtual server, or other circuits suitable for executing instructions or performing logic operations. In some embodiments, the at least one processor 202 or 220 may include more than one processor. Each processor of the more than one processors may have similar construction or the processors of the more than one processors may be of differing constructions that are electrically connected or disconnected from each other. For example, the processors (e.g., 202 and/or 220) may be separate circuits or integrated in a single circuit. When more than one processor (e.g., 202 and/or 220) is used, the processors (e.g., 202 and/or 220) may be configured to operate independently or collaboratively, and may be co-located or located remotely from each other. The processors may be coupled electrically, magnetically, optically, acoustically, mechanically or by any other means that permit them to interact.

The instructions executed by the at least one processors (e.g., 202 and/or 220) may, for example, be pre-loaded into a memory (e.g., 206 and/or 222), integrated with or embedded into the controller or may be stored in a separate memory. Each of memories 206 and 222 may include a Random Access Memory (RAM), a Read-Only Memory (ROM), a hard disk, an optical disk, a magnetic medium, a flash memory, other permanent, fixed, or volatile memory, or any other mechanism capable of storing instructions. As used herein, a memory (e.g., 206 and/or 222), may be any type of physical memory in which information or data readable by at least one processor may be stored. Examples of memory include Random Access Memory (RAM), Read-Only Memory (ROM), volatile memory, non-volatile memory, hard drives, CD ROMs, DVDs, flash drives, disks, any other optical data storage medium, any physical medium with patterns of holes, markers, or other readable elements, a PROM, an EPROM, a FLASH-EPROM or any other flash memory, NVRAM, a cache, a register, any other memory chip or cartridge, and networked versions of the same.

The term “memory” (e.g., memory 206 and/or 222) may refer to multiple structures, such as a plurality of memories or computer-readable storage media located within an input unit or at a remote location. Additionally, one or more computer-readable storage mediums may be utilized in implementing a computer-implemented method. The memory may include one or more separate storage devices collocated or disbursed, capable of storing data structures, instructions, or any other data. The memory may further include a memory portion containing instructions for the processor to execute. The memory may also be used as a working scratch pad for the processors (e.g., processors 202 and/or 220) or as a temporary storage. Accordingly, the term computer-readable storage medium should be understood to include tangible items and exclude carrier waves and transient signals.

Some embodiments may involve displaying information on a graphical user interface, e.g., user interface 226), as shown in FIG. 2B. User interface 226 may be part of a computing device (e.g., 212) that has inputs and outputs. Accordingly, party computing device 212 may be a device that has the functionality necessary to realize user interface 226, for example, a mobile device, desktop, laptop, tablet, or any other devices capable of displaying, receiving, and processing data. Such a computing device (e.g., 212) may also include a display such as an LED display, interactive display, augmented reality (AR) or virtual reality (VR) display.

User interface (e.g., 226) may contain information entry fields 232 for receiving a party/counterparty’s user input 230. Information entry fields 232 may provide different means for a party/counterparty using the user interface 226 to enter information that is eventually received by a processor (e.g., 202 and/or 220). By way of example, information entry fields 232 may include a link, a button element, a drop-down menu, or an empty field for the user, a modal, or other elements, to type in or upload documents. A user input 230 may be any information the party/counterparty using user interface 226 enters or uploads. In some embodiments, this user input may include activity-related data including party name, activity name, counterparty name, counterparty contact information, source account information, beneficiary account information, authorized signatory, or fund distribution parameters (e.g., beneficiary name, beneficiary account information, distribution amount, payment method, etc.) that a party enters into empty fields in information entry field 232. In some embodiments, user input 230 may include a party’s initiation of an online activity, which may involve clicking a button in information entry field 232. In some embodiments, user input 230 may include additional activity-related data (e.g., filing in missing parts of joint written instructions, updates/changes to what was provided by a party) provided by a counterparty via empty fields in the information entry field 232.

User interface 226 may also contain a visualization output 228. Processor 202 and/or 220 may communicate display 224 to user interface 226 for display on visualization output 228. A visualization output 228 may be any kind of display screen that may visually display information to a party/counterparty. For example, a visualization output may be rendered on a mobile phone screen, a laptop computer screen, a desktop computer screen, or a virtual screen in VR display. Display 224 may include the data that is displayed on visualization output 228. For example, display 224 may include a list of activities associated with one of a plurality of parties. In some embodiments, display 224 may include a web page in which a party involved in a secure online activity may upload documents related to an online activity. In some embodiments, display 224 may include web pages to guide a party to set up a direction to release or a joint written instruction for an escrow agreement.

Disclosed embodiments may include and/or access a data structure. A data structure consistent with the present disclosure may include any collection of data values and relationships among them. The data may be stored linearly, horizontally, hierarchically, relationally, non-relationally, uni-dimensionally, multidimensionally, operationally, in an ordered manner, in an unordered manner, in an object-oriented manner, in a centralized manner, in a decentralized manner, in a distributed manner, in a custom manner, or in any manner enabling data access. By way of non-limiting examples, data structures may include an array, an associative array, a linked list, a binary tree, a balanced tree, a heap, a stack, a queue, a set, a hash table, a record, a tagged union, ER model, and a graph. For example, a data structure may include an XML database, an RDBMS database, an SQL database or NoSQL alternatives for data storage/search such as, for example, MongoDB, Redis, Couchbase, Datastax Enterprise Graph, Elastic Search, Splunk, Solr, Cassandra, Amazon DynamoDB, Scylla, HBase, and Neo4J. A data structure may be a component disclosed system 200, a component of database 208 or a remote computing component (e.g., a cloud-based data structure). Data in the data structure may be stored in contiguous or non-contiguous memory. Moreover, a data structure, as used herein, does not require information to be co-located. It may be distributed across multiple servers (e.g., 204), for example, that may be owned or operated by the same or different entities. Thus, the term “data structure” as used herein in the singular is inclusive of plural data structures.

Certain embodiments disclosed herein may include a processor (e.g., 202 and/or 220) configured to perform methods that may include triggering an action in response to an input. The input may be from a user action, for example, a user input 230 in information entry fields 232. A trigger may include an input of a data item that is recognized by at least one processor (e.g., 202 and/or 220) that brings about another action.

Various embodiments are described herein with reference to a system, method, device, or computer readable medium. It is intended that the disclosure of one is a disclosure of all. For example, it is to be understood that disclosure of a computer readable medium described herein also constitutes a disclosure of methods implemented by the computer readable medium, and systems and devices for implementing those methods, via for example, at least one processor (e.g., 202 and/or 220). It is to be understood that this form of disclosure is for ease of discussion only, and one or more aspects of one embodiment herein may be combined with one or more aspects of other embodiments herein, within the intended scope of this disclosure.

Embodiments described herein may refer to a non-transitory computer readable medium containing instructions that when executed by at least one processor (e.g., 202 and/or 220), cause the at least one processor to perform a method. Non-transitory computer readable mediums may be any medium capable of storing data in any memory (e.g., 206 and/or 222) in a way that may be read by any computing device with a processor (e.g., 202 and/or 220) to carry out methods or any other instructions stored in the memory (e.g., 206 and/or 222). The non-transitory computer readable medium may be implemented as hardware, firmware, software, or any combination thereof. Moreover, the software may preferably be implemented as an application program tangibly embodied on a program storage unit or computer readable medium consisting of parts, or of certain devices and/or a combination of devices. The application program may be uploaded to, and executed by, a machine comprising any suitable architecture. Preferably, the machine may be implemented on a computer platform having hardware such as one or more central processing units (“CPUs”) (e.g., 202 and/or 220), a memory (e.g., 206 and/or 222), and input/output interfaces (e.g., 224, 232, and/or 226). The computer platform may also include an operating system and microinstruction code. The various processes and functions described in this disclosure may be either part of the microinstruction code or part of the application program, or any combination thereof, which may be executed by a CPU, whether or not such a computer or processor (e.g., 202 and/or 220) is explicitly shown. In addition, various other peripheral units may be connected to the computer platform such as an additional data storage unit and a printing unit. Furthermore, a non-transitory computer readable medium may be any computer readable medium except for a transitory propagating signal.

Processor 202 and/or 220 may run computer applications. Applications may be mobile computer programs configured to run on mobile phones or tablet computers. Applications may also be computer programs configured to run on laptop computers or desktop computers. Computer applications are computer software packages designed to carry out specific tasks. Some applications may be front-end applications that interact directly with of a computer or mobile device user. Processor 220 may be included in party computing device 212 and/or 214 and may, for example, run front-end applications. Back-end applications may handle and process requests from front-end applications, manage data, and perform business logic. Back-end applications may consist of a variety of services, including RESTful APIs, microservices, and other middleware components. Back-end applications may operate behind the scenes, providing the necessary infrastructure to support the user-facing elements of front-end applications. A front-end application may call the back-end application to process data or to retrieve or access data. Processor 202 included in server 204 may, for example, run back-end applications.

Embodiments described herein may refer to methods that include various steps. Unless the order is characterized as necessary, the steps of methods described herein may be performed in any order possible to achieve the results of the method.

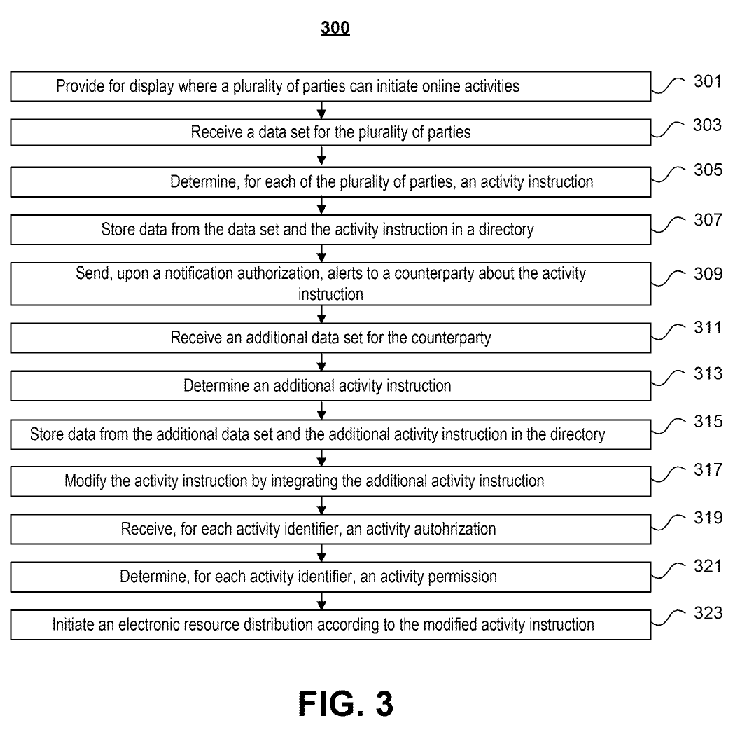

FIG. 3 is a flow diagram illustrating an exemplary method 300 for a secure online activity. Method 300 may be practiced on system 200. Method 300 may be used to initiate and process a secure online activity such as an escrow transaction securely by determining an activity instruction based upon data provided by parties and/or counterparties involved in the online activity. In some embodiments, an activity instruction may be a joint written instruction that provides clear mutual consent and/or direction on how the escrow transaction should proceed based on transaction-related data entered or uploaded by parties and counterparties for the escrow. In other embodiments, an activity instruction may be a claim request (i.e., a formal request for payment or capital in a financial transaction). In these embodiments, method 300 may be used by a party to track and arrange electronic resource distributions (e.g., fund distributions) according to the activity instruction.

Method 300 includes a step 301 of providing for display, on a graphical user interface, for a plurality of parties to initiate online activities. How a plurality of parties may initiate online activities is described in detail below as used in method 300.

In some embodiments, a plurality of parties may initiate online activities by accessing a web page or web pages provided by a web application, as described with respect to FIG. 1B. A web page may be a graphical user interface object that allows multiple input fields, buttons, panels, or documents to be contained within that page. Web pages may display lists, documents, or groups of information in a graphical user interface. An online activity may be initiated when a party inputs information for creating a new online activity in information entry fields displayed on a web page or across multiple web pages in user interface, consistent with disclosed embodiments. An online activity also may be initiated when a party selects one of past online activities from a web page that displays a list of past online activities and inputs updated or modified information for a new online activity. In some embodiments, a new escrow instruction may be set up after a party follows through web pages which collect necessary information for the escrow activity including party account information, distribution information, signatory information, and reference instructions.

Method 300 may include a step 303 of receiving a data set for a plurality of parties, wherein the data set includes, for each of the plurality of parties, at least one of a party identifier, an activity identifier associated with the party, a counterparty identifier, an activity source account identifier, a beneficiary account identifier, a party authorized signatory, or distribution parameters.

Each party may be an individual, a company, a business, a non-profit, or other similar individuals or organizations that may engage in online activities. In some embodiments, the party may be a buyer or buyer’s counsel in an escrow activity who may transfer activity-related documents or make payments to purchase a property. The party may own a bank account that may send a payment to the counterparty via a web application by providing an activity instruction (e.g., payment instruction set up through the application, written instruction of the party, or joint written instruction).

A party identifier may be a string of letters and/or numbers that uniquely identifies a party, such as the name of a party, an identification number, a username, or any other combination of letters and numbers that is uniquely associated with the party.

An activity identifier associated with the party may be a string of letters and/or numbers that uniquely identifies an activity, such as the name of a deal, an activity identification number, or any other combination of letters and numbers that is uniquely associated with the activity the party is initiating.

A counterparty identifier may be a string of letters and/or numbers that uniquely identifies a counterparty, such as the name of a counterparty, an identification number, a username, or any other combination of letters and numbers that is uniquely associated with the counterparty.

An activity source account identifier may be a string of letters and/or numbers that uniquely identifies an account to be disbursed when an activity is completed.

A beneficiary account identifier may be a string of letters and/or numbers that uniquely identifies an account to receive a disbursement when an activity is completed.

A party authorized signatory may refer to a designated individual who has been given the right to sign on behalf of the party and information related to the designated individual, including the name of the individual and contact information. In some embodiments, authorized signatories that a party may choose for each distribution may be determined according to activities associated with the source account for that distribution. If any subsequent chosen source account for a different activity has different signers than the first chosen source account, then the authorized signatories for the first chosen account may be disabled.

In some embodiments, external files related to an online activity may be uploaded via a web application by a party. External files may be any activity-related documents such as contracts, identification verifications, signed documents, power of attorney, and other documents containing sensitive activity-related information. In some embodiments, a party may upload external files via a file upload page or modal to store the external files in a directory.

Distribution parameters may be information regarding how resources from the source account should be distributed following an activity instruction. In some embodiments, the information may include a disbursement or payment amount, the name of payee, payment method or instruction (e.g., ACH, wire, check, etc.), and payee account information.

A data set may be a group of data elements stored in a manner such that the data elements may be organized and associated with each other. The organization and association may depend on how data may be collected or displayed through a web page or across web pages. For example, data elements may include party identifiers, activity identifiers associated with the parties, and activity source account identifiers. For any given party, these data elements may be associated with each other in memory, consistent with disclosed embodiments. The data elements for a plurality of parties may be compiled into an overall data set stored in memory, consistent with disclosed embodiments. The data elements that make up the data set may be associated using any means for associating data. Some examples of associating data may include using a linked list, a look up table, or by storing the first entity information in the same database record, or by using other similar methods. A linked list may consist of nodes stored in memory, consistent with disclosed embodiments. A node may include a basic unit in a data structure, such as a linked list, and each node may contain a data field and a reference to the next node in the list. A look up table may be an array of data in memory, consistent with disclosed embodiments, that may map input values to output values. Given a set of input values, the at least one processor may query a look up table to retrieve the corresponding output values from the table. For example, if a look up table maps a party identifier to a location in memory storing the data elements for that party and its online activities linked to activity identifiers associated with the party, then by inputting that party identifier, a processor, consistent with disclosed embodiments, may access and retrieve the data elements associated with that party and its online activities linked to activity identifiers associated with the party as an output for use in method 300. As another example, a database record may be a collection of information organized in a table that pertains to a specific topic or category.

A processor may receive each of party identifier, activity identifier associated with the party, counterparty identifier, activity source account identifier, beneficiary account identifier, party authorized signatory, external files, or distribution parameters from either a party computing device, a counterparty computing device, or a combination of the two, over network, consistent with disclosed embodiments. The processor may then store this data set in a memory. The processor may then subsequently access this data in the memory to process secure online activity and update user interface, consistent with disclosed embodiments, accordingly by transmitting updated data sets and /or displays to the processor located at a party computing device and displaying updated information. This data may be associated with each other in the memory when received by the processor.

In some embodiments, web pages may display a plurality of lists associated with at least one of: a party identifier, an activity identifier associated with a party, a counterparty identifier, an activity source account identifier, a beneficiary account identifier, a party authorized signatory, a counterparty signatory, distribution parameters, or any combination thereof.

Method 300 may include a step 305 of determining, for each of the plurality of parties, an activity instruction based on the received data set. An activity instruction may be an organized set of data representing an instruction on how to complete a transaction such as transferring of funds, buying or selling assets, or processing payments. In some embodiments, an activity instruction may include data on direction to release for an escrow activity. The direction to release may instruct an escrow agent or other third-party agents about how funds or other assets should be distributed (e.g., timeline of distribution, conditions needed to be met before such distribution, etc.) to a party and/or counterparty involved in the escrow activity. The activity instruction may include data input from the escrow agent or other third-party agents in addition to data input provided by parties to the activity. An escrow agent may be a bank that the parties to the activity have an account with. In some embodiments, an activity instruction may include data on a joint written instruction between a party and a counterparty. In some embodiments, an activity instruction may be automatically determined and populated based on a previously received data set. The automatically populated activity instruction may be based on at least one of: a party identifier, an activity identifier associated with a party, a counterparty identifier, an activity source account identifier, a beneficiary account identifier, a party authorized signatory, a counterparty signatory or distribution parameters. A party may overwrite a data element in the previously received data set and modify the automatically populated activity instruction.

Method 300 may include a step 307 of storing data from the data set and the activity instruction in a directory. A directory may be associated with the counterparty, and it may be a linked list, look up table, database record, or other similar data structure that stores all the nodes of data elements from a party. In some embodiments, this directory may be a directory storing data for allowing the party to send a payment to the counterparty via a web application by providing an activity instruction. Step 307 may be achieved by a processor storing each data element in the appropriate location in the data structure stored in memory, consistent with disclosed embodiments. For example, in some embodiments, step 307 may be achieved by a processor storing each data element in the data field of the linked list node associated with the appropriate given party in memory, consistent with disclosed embodiments. In some embodiments, data for a joint written instruction in an escrow activity may be stored by a party initiating the escrow activity and the data may be accessed by a counterparty.

Method 300 may include a step 309 of sending, upon a notification authorization, an alert to a counterparty about the activity instruction. An alert may be a short message service (SMS) text message, a push notification message on an online banking application, an email, or any combination thereof that notifies the counterparty about an activity instruction provided by a party initiating an online activity. A party may provide the counterparty’s cell phone number, email address, and/or other contact information to deliver alerts to the counterparty via a web application. A notification authorization may be an indication from the party or third-party agent that communication to the counterparty that the activity instruction is approved. A notification authorization may be initially set to not authorized status, and it may be updated to authorized status. In some embodiments, notification authorization may be received when a party submits an escrow instruction via a web application after inputting all necessary data for an escrow activity. A notification system administrator, for example, a platform business partner, may be a third-party agent that defines alerts and alert templates to be used by a web application.

Method 300 may include a step 311 of receiving an additional data set for the counterparty, wherein the additional data set includes at least one of a counterparty identifier, a counterparty authorized signatory, or changes to the distribution parameters.

The counterparty may be an individual, a company, a business, a non-profit, or other similar individuals or organizations that may engage in online activities with a party. In some embodiments, the counterparty may be a seller or seller’s counsel in an escrow activity who may transfer activity-related documents or transfer a property after receiving payments. The counterparty may own a bank account that may receive a payment from the party when the escrow activity is completed.

A counterparty authorized signatory may refer to a designated individual who has been given the right to sign on behalf of the counterparty and information related to the designated individual, including the name of the individual and contact information. In some embodiments, external files related to an online activity may be uploaded via a web application by a counterparty. External files may be any activity-related documents such as contracts, identification verifications, signed documents, power of attorney, and other documents containing sensitive activity-related information. In some embodiments, a counterparty may upload external files via a file upload page or modal to store the external files in a directory. Distribution parameters may be information regarding how funds from the source account should be disbursed following an activity instruction or information regarding timeline of distribution when conditions are met. The distribution parameters set by a party at the initiation of an online activity may be updated or modified by the counterparty.

Method 300 may include a step 313 of determining an additional activity instruction based on the received additional data set. An additional activity instruction may modify an activity instruction initially provided by a party via changing or adding information initially included in the activity instruction. In some embodiments, a counterparty may change the terms and conditions of an escrow activity after receiving a notice of initial terms and conditions of the escrow activity set by a party. An additional activity instruction may include necessary but missing data for a party-initiated online activity. The additional activity instruction may also include changes to existing data in for the online activity. In some embodiments, an activity instruction may include escrow transaction direction set by a party and an additional activity instruction may include an authorized signatory provided by a counterparty. In some embodiments, a new escrow instruction set up by a party that indicates payment amount and reference instructions on payment may be an activity instruction. In some embodiments, a change to reference instructions on payment after a counterparty provides additional information (e.g., changes to dates of payment, changes of conditions for payment, etc.) may be an additional activity instruction.

Method 300 may include a step 315 of storing data from the additional date set and the additional activity instruction in the directory. In some embodiments, the directory may be a directory storing data for enabling and/or changing the way a party may send a payment to the counterparty via a web application. Step 315 may be achieved by a processor storing each data element in the appropriate location in the data structure stored in memory, consistent with disclosed embodiments. For example, in some embodiments, step 315 may be achieved by a processor storing each data element in the data field of the linked list node associated with the appropriate given party in memory, consistent with disclosed embodiments.

A processor may receive each of counterparty identifier, a counterparty authorized signatory, external files, or changes to the distribution parameters from either a party computing device, a counterparty computing device, or a combination of the two, over network, consistent with disclosed embodiments. The processor may then store this data set in the memory. The processor may then subsequently access this data in the memory to process secure online activity and may update a user interface accordingly by transmitting updated data sets and /or displays to a processor located at a counterparty computing device and displaying updated information on its user interface. This data may be associated with each other in memory, consistent with disclosed embodiments when received by the processor.

Method 300 may include a step 317 of modifying the activity instruction by integrating the additional activity instruction therein. The activity instruction determined in step 305 may be updated by incorporating additional data supplied by a counterparty. In some embodiments, an activity instruction, such as an escrow instruction, set up by a party may indicate a certain payment amount to be made on a certain day after agent checking whether payment conditions are met. A counterparty may provide additional information supplied by a new agreement between the party and the counterparty, which may indicate the payment should be made on another day. The activity instruction may then be updated according to the additional information for the counterparty.

Method 300 may include a step 319 of receiving, for each activity identifier, an activity authorization associated with the activity identifier. An activity authorization may be an indication that an online activity associated with a party is approved and that the online activity may be initiated and completed. In some embodiments, activity authorization may be payment authorization. In some embodiments, a processor may approve an escrow transaction after checking all the necessary transaction-related data if the escrow transaction is eligible for authorization and a buyer has proper funds to complete the escrow activity. An activity may be eligible for authorization if the activity authorization is currently set to not authorized. After the activity authorization is supplied, a processor may store this activity authorization indication in memory, consistent with disclosed embodiments, for later use. An activity instruction may not be authorized if the instruction lacks the required data for approval. An online activity may not be initiated or completed if the activity instruction is not authorized. An activity may remain with an unauthorized status if it is not approved.

Method 300 may include a step 321 of determining, for each activity identifier, an activity permission associated with the activity identifier. An activity permission may be an indication generated by a processor that an online activity may be eligible to be authorized, initiated, and completed. For example, a activity permission may demonstrate that all requisite data has been received from both a party and a counterparty and that the data was reviewed to ensure that it is appropriate to complete the online activity when authorized. The activity permissions may be categorized as eligible to indicate that the counterparty is permitted to receive funds based on the modified activity instruction. The activity permission may also need to be authorized to initiate and complete an online activity. Completing the online activity may involve a transfer of electronic contents from one party repository to another. In some embodiments, completing an online activity may involve a transfer of electronic funds from a bank account owned by the party to a bank account owned by the counterparty when the party is making a payment to the counterparty. The activity permission may be determined by a processor setting a variable in memory, consistent with disclosed embodiments, to permitted. In some embodiments, the variable may be set to a number, letter, symbol, or any combination thereof that may represent that an activity is permitted after system checks all requisite data for the activity. In some embodiments, an activity permission based on the activity authorization, the activity instruction, the data set and the additional data set may be set to permitted if there is no missing requisite data.

Method 300 may include a step 323 of initiating an electronic resource distribution according to the modified activity instruction. Resource distributions for online activities may occur between a party repository associated with the party and a counterparty repository associated with the counterparty. In some embodiments, the party’s repository and the counterparty’s repository may be electronic accounts that are maintained by an institution such as a bank, and the online activities may be completed through an electronic fund disbursement from the party to the counterparty or vice versa.

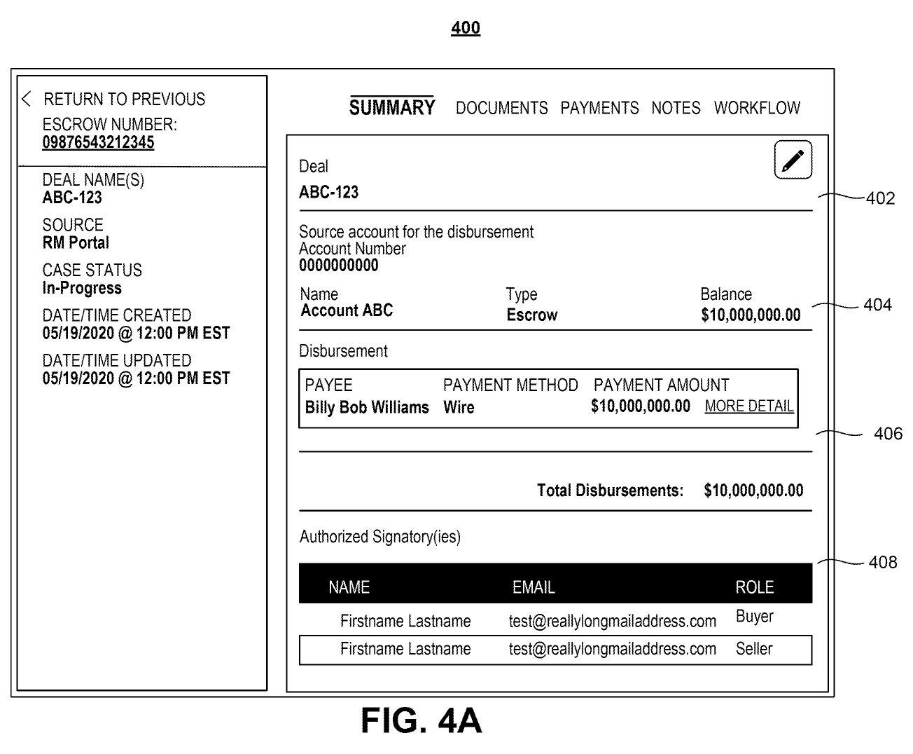

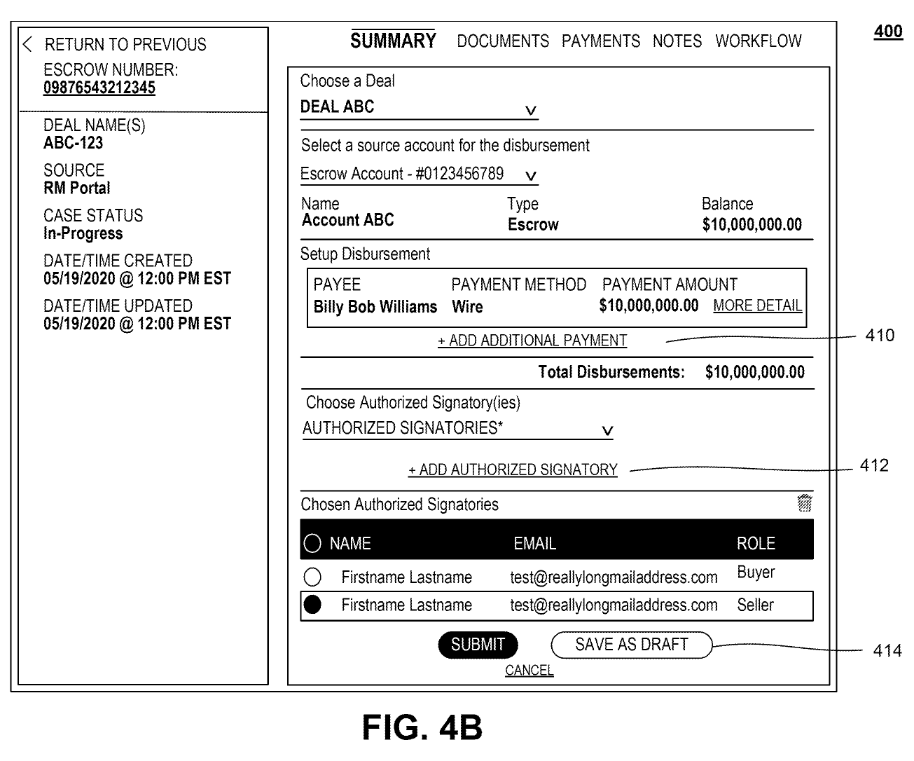

FIG. 4A is an exemplary display on a graphical user interface displaying an overview of a secure online activity to a party in the online activity, consistent with disclosed embodiments. Web page 400 may be accessible by a party to view and manage an online activity. Web page 400 may be a dashboard configuration such as a user interface included in party computing device, as described in FIG. 2B. A processor of party computing device may execute a computer application that runs web application, which may display web page 400. The party may view displayed information on user interface rendered by visualization output. Web page 400 may include an activity identifier section 402, a source account section 404, a distribution section 406, an authorized signatory section 408, and other activity-related information section. Activity identifier section 402 may be a segment of a web page that displays an activity identifier, such as the name of a deal, an activity identification number, or any other combination of letters and numbers that is uniquely associated with an activity. Source account section 404 may be a segment of a web page that displays an activity source account identifier identifying an account to be disbursed when an activity is completed. Distribution section 406 may be a segment of a web page that displays distribution parameters, such as disbursement or payment amount, the name of payee, payment method or instruction (e.g., ACH, wire, check, etc.), and payee account information. Authorized signatory section 408 may be a segment of a web page that displays authorized signatory that may include information of a designated individual who has been given the right to sign on behalf of a party. In some embodiments, details regarding an escrow activity may be displayed. This information may include deal name, source account details (e.g., account number, name, type, balance, etc.), distribution details (e.g., payee name, payment method, payment amount etc.), and available authorized signatories.

FIG. 4B is an exemplary display on a graphical user interface wherein a secure online activity is edited by a party in the activity, consistent with disclosed embodiments. Web page 400 may be accessible by a party to edit a secure online activity. A party may input information using web page 400. The party may interact with the web page through information entry fields and view displayed information on a user interface. The party may choose a different activity identifier or source account identifier and may add additional distribution parameters via add-distribution link 410 or authorized signatories via add-signatory link 412. Web page 400 may include a plurality of buttons 414 to process activity-related data via a web application. Add-distribution link 410 may be a reference that points to another resource, such as a web page, document, or file, in which a party may add new distribution parameters. Add-signatory link 412 may be a reference that points to another resource, in which a party may add a new authorized signatory. In some embodiments, a party may edit an escrow activity by adding additional payment and/or adding more authorized signatories. The edited activity may be submitted or saved as a draft.

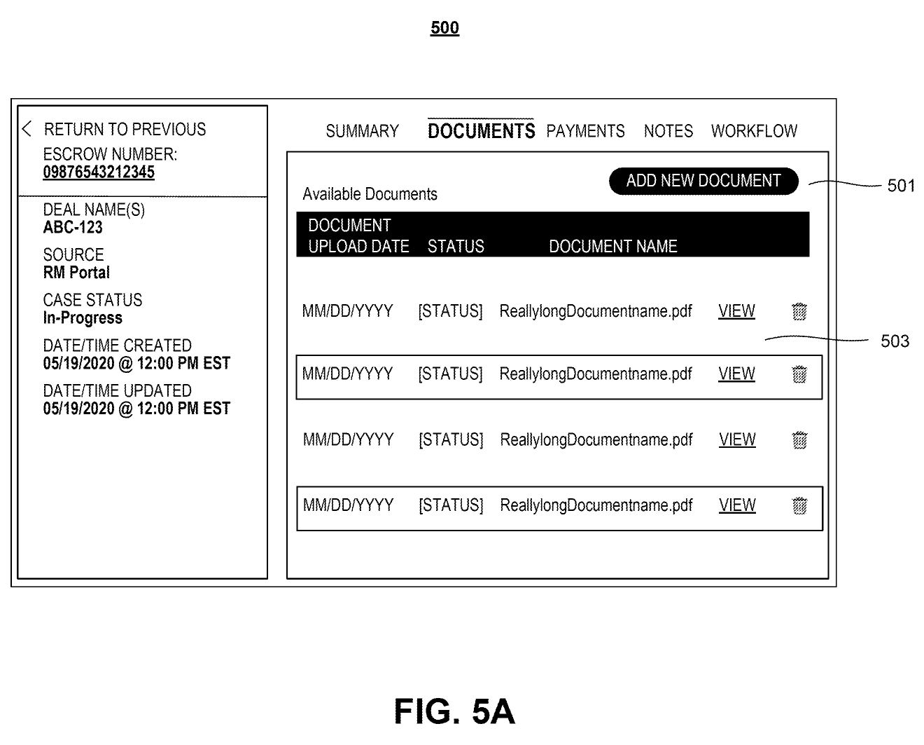

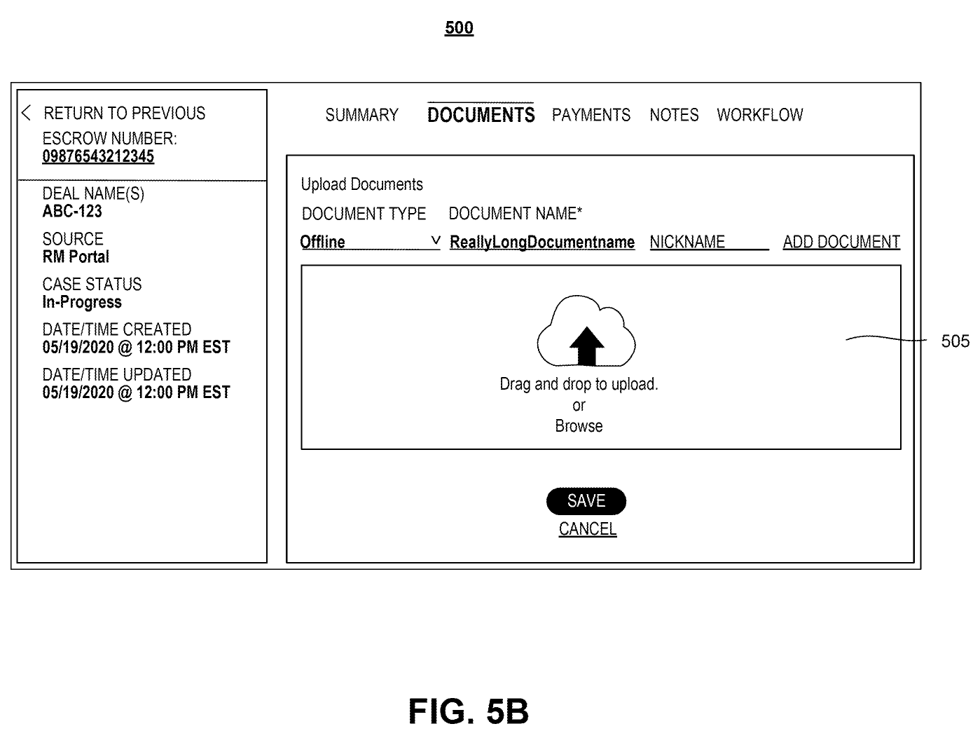

FIG. 5A is an exemplary display on a graphical user interface displaying available documents for a party involved in a secure online activity, consistent with disclosed embodiments. Web page 500 may be accessible to view activity-related documents. A list of available documents 503 for a party may be displayed so the party may manage the documents. A button 501 may allow the party to add a new document. In some embodiments, the list of available documents may include several columns. These columns may include a document upload date, a status, a document name, and a delete button that may remove a document. There may be a “add new document” button that may allow a party to upload external documents related to an online activity.

FIG. 5B is an exemplary display on a graphical user interface illustrating a party involved in a secure online activity uploading new documents, consistent with disclosed embodiments. Web page 500 may be accessible by a party to upload activity-related documents via user upload area 505. In some embodiments, a party may upload new documents such as external files by dragging and dropping the documents or by browsing a local drive on a party computing device to locate the documents. In some embodiments, a counterparty, in an escrow transaction, may upload a receipt showing that the counterparty has made a deposit to an escrow account to prove that one of the escrow conditions has been met. In other embodiments, either a party or counterparty may upload a contractual document that shows the changes made to the escrow conditions upon mutual agreement.

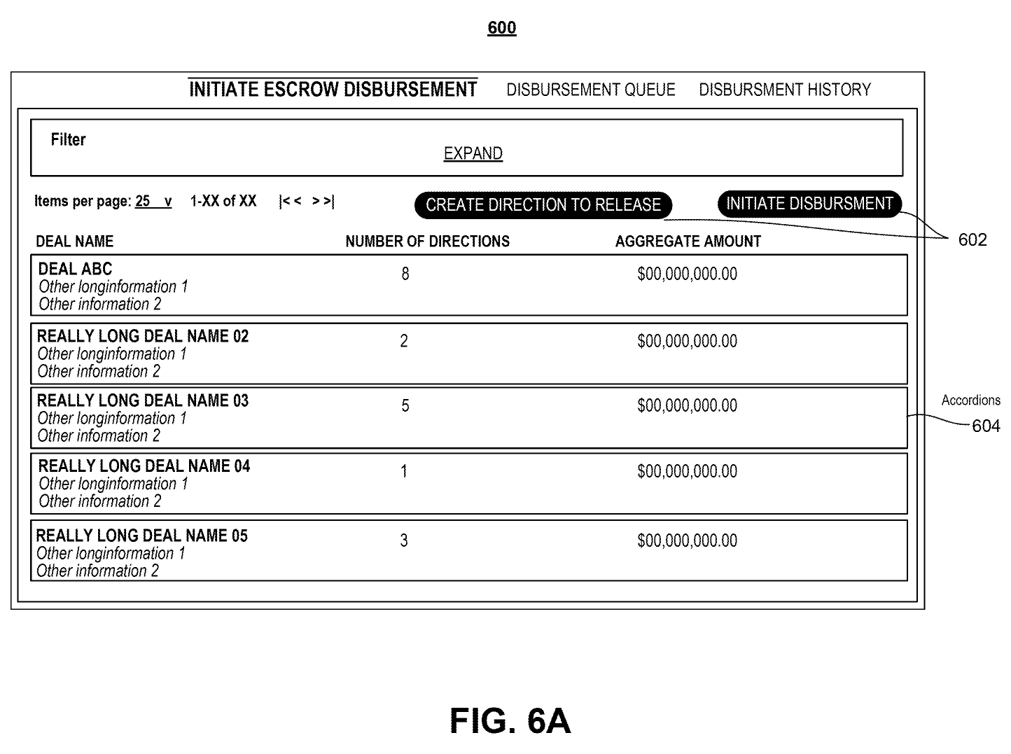

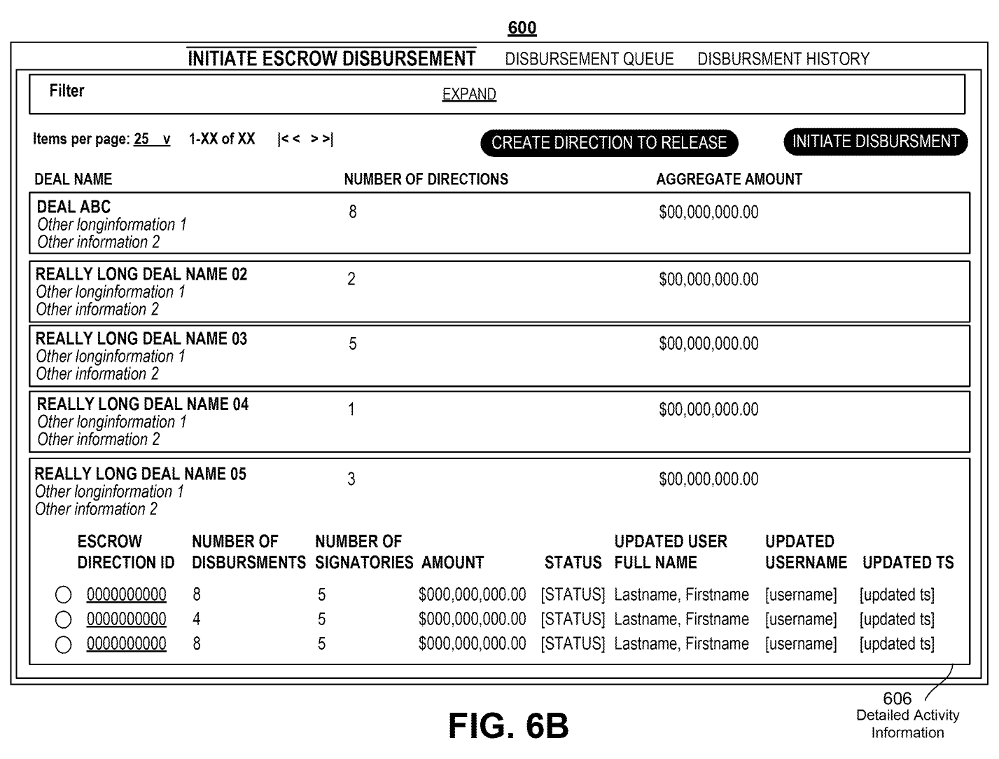

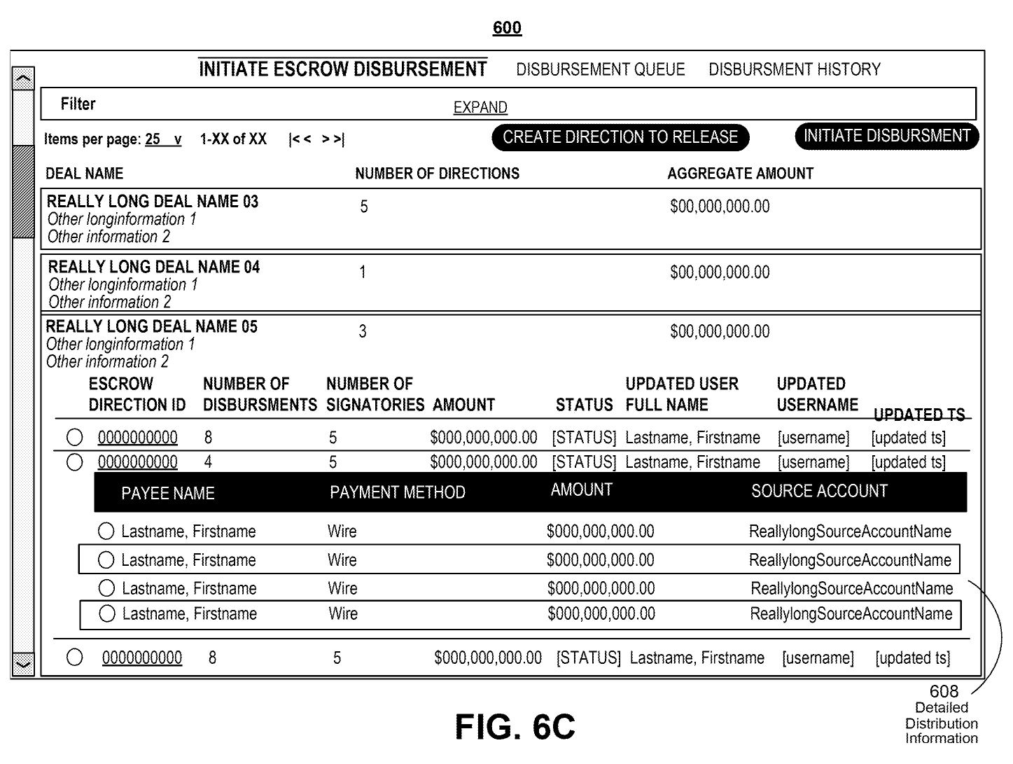

FIG. 6A is an exemplary display on a graphical user interface illustrating initiation of a secure online activity, consistent with disclosed embodiments. Web page 600 may be accessible by a party to initiate a secure online activity, such as an escrow distribution. Web page 600 may include button 602 to create a new activity instruction or to initiate distribution for an activity instruction saved earlier via a web application. The web page may include accordions 604 that display past activity instructions that may have been processed or saved by a party. Accordions 604, when selected, may display a group of more detailed information about the selected activity instruction. In some embodiments, buttons 602 may be “create direction to release” and/or “initiate distribution” buttons for an escrow activity, consistent with disclosed embodiments. The “create direction to release” button may allow a party to create or start a new escrow instruction and the “initiate distribution” button may allow a party to initiate an escrow disbursement from an existing escrow instruction. In some embodiments, accordions 604 may be a menu composed of vertically stacked headers that reveal more details when triggered. For example, as disclosed herein, the accordions may display a deal name, number of directions, and aggregate amount of an escrow activity, which may provide an easily accessible summary of information while allowing a party to access more detailed information by expanding an accordion header.

FIG. 6B is an exemplary display on a graphical user interface wherein a list item, from the list of secure online activities that may be initiated, is expanded, consistent with disclosed embodiments. Web page 600 may include one of the accordions 604 expanded when one of the accordion headers is selected by a party. The expanded accordion may display a detailed activity information section 606 about the selected activity instruction. In some embodiments, detailed activity information section 606 may include several columns. These columns may include an escrow instruction identification column, a number of disbursement column, a number of signatories column, a disbursement amount column, status column, an updated user full name column, and an updated username column for a specific escrow activity.

FIG. 6C is an exemplary display on a graphical user interface wherein a list item, from the list of secure online activities that may be initiated, is further expanded, consistent with disclosed embodiments. Web page 600 may include one of the accordion’s detailed activity information sections 606 further expanded when one of the activity detailed sections is selected by a party. The further expanded accordion’s detailed activity information section may display a list of detailed distribution information section 608. In some embodiments, detailed distribution information section 608 may include several columns. These columns may include a payee name column, a payment method column, an amount column, and a source account column for a specific distribution for an escrow activity.

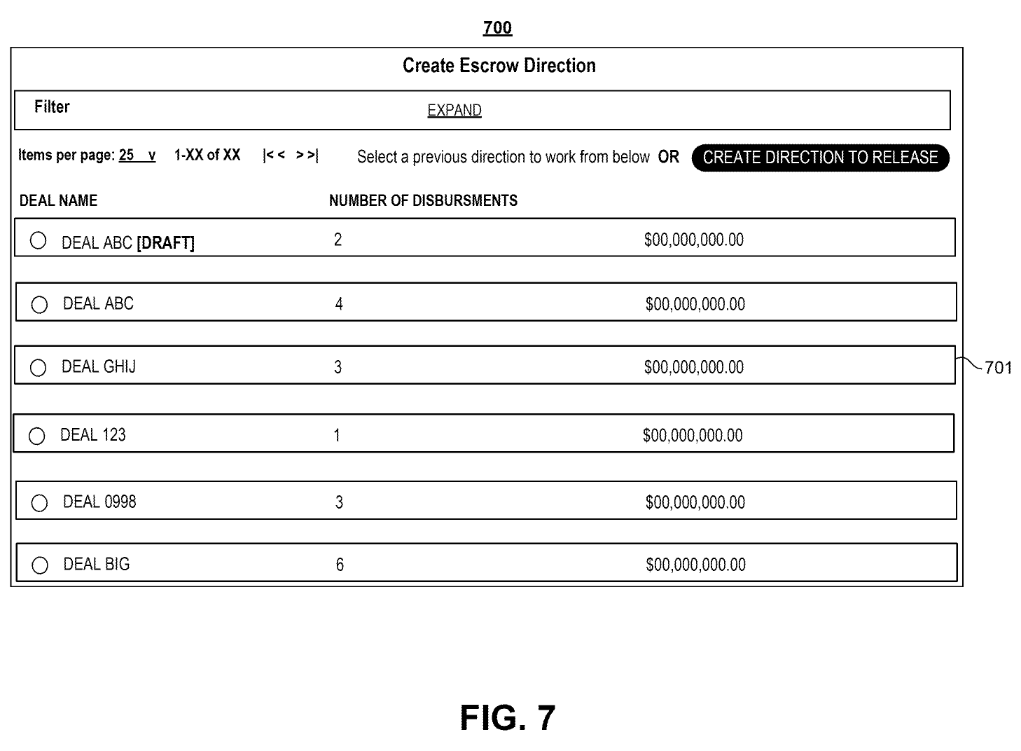

FIG. 7 is an exemplary display on a graphical user interface of selecting an activity instruction, consistent with disclosed embodiments. Web page 700 may be accessible by a party to select an activity instruction. The web page may include list 701 that displays past activity instructions or saved activity instructions by the party. The party may select an activity instruction from the list instead of creating a new instruction by inputting all necessary information for a secure instruction.

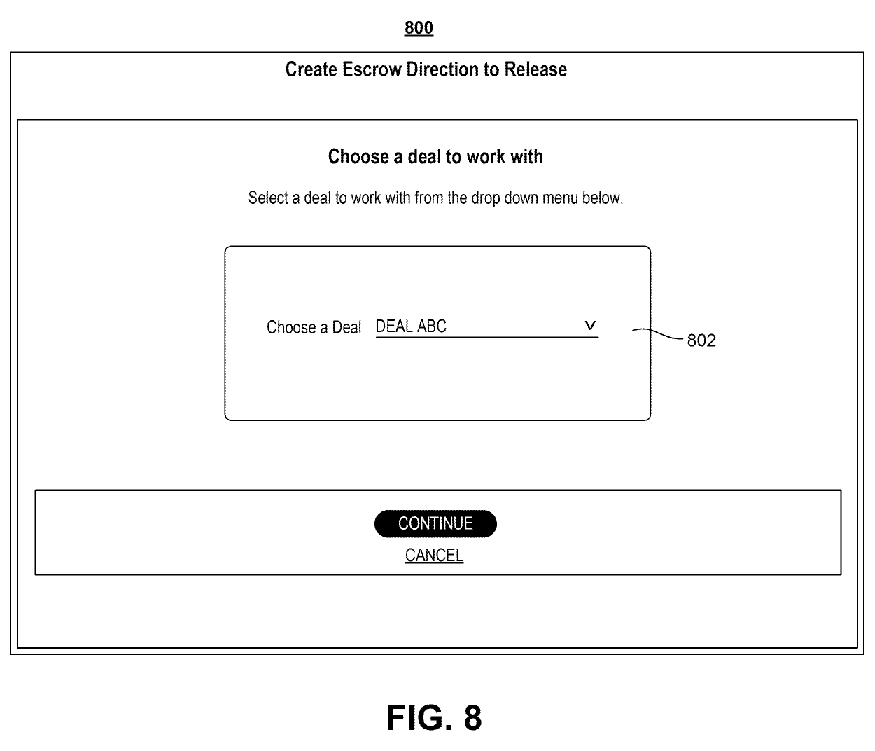

FIG. 8 is an exemplary display on a graphical user interface illustrating selection of an activity identifier to set up an activity instruction, consistent with disclosed embodiments. Web page 800 may be accessed by a party to create a new activity instruction by selecting an activity identifier. The party may choose an activity identifier in an activity identifier selection section 802 and submitting the selection. In some embodiments, activity identifier selection section 802 may include a drop-down menu, listing existing deal names for an escrow activity. A party initiating the escrow activity may create a new escrow instruction by choosing a deal to work with.

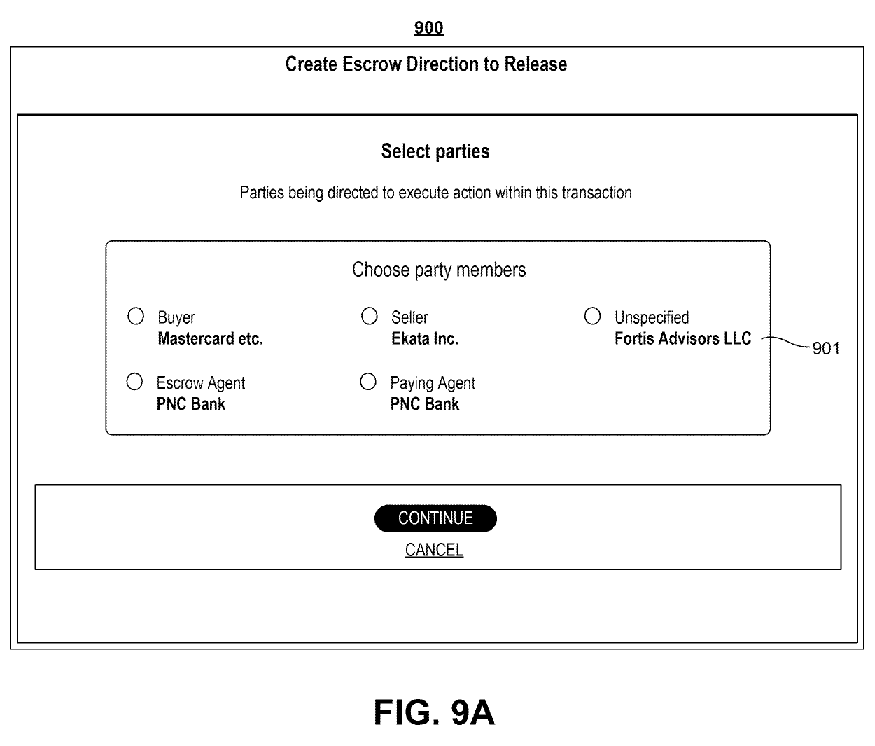

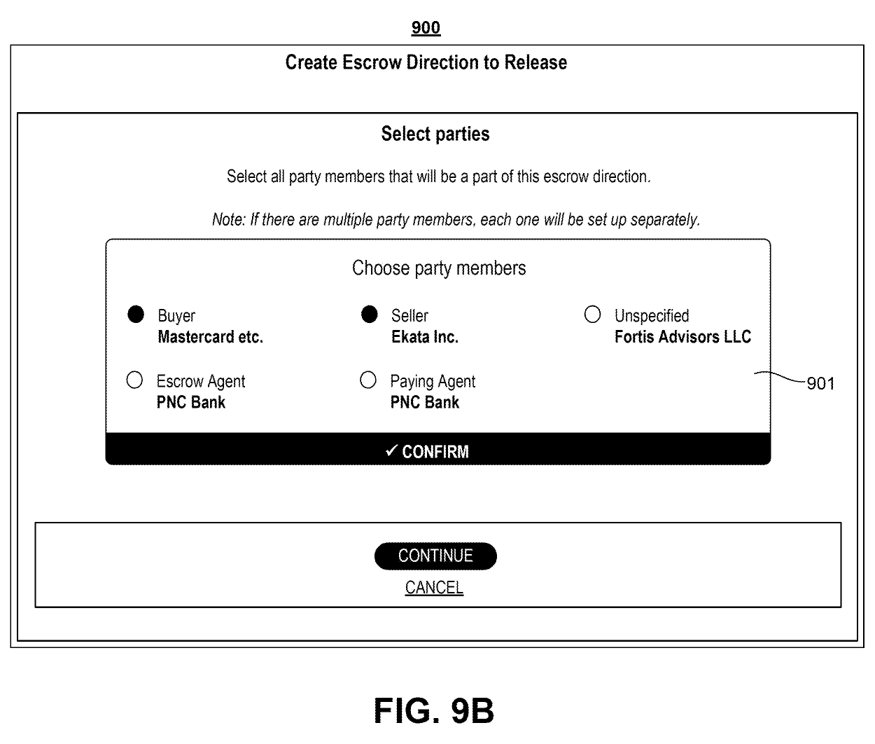

FIG. 9A is an exemplary display on a graphical user interface illustrating selecting participants in a secure online activity for an activity instruction, consistent with disclosed embodiments. Web page 900 may be accessed by a party to create a new activity instruction by selecting a party identifier, a counterparty identifier, and third-party agent identifier(s). A third-party agent identifier may be a string of letters and/or numbers that uniquely identifies a third-party agent, such as the name of a third-party agent, an identification number, a username, or any other combination of letters and numbers that is uniquely associated with the third-party agent. The party may choose identifiers for activity participants in a participants selection section 901 and submitting the selection. In some embodiments, participants selection section 901 may include buttons associated with party member names for an escrow activity. A party initiating the escrow activity may create a new escrow instruction by choosing party members for the activity.

FIG. 9B is an exemplary display on a graphical user interface of displaying selected participants in a secure online activity for an activity instruction, consistent with disclosed embodiments. Web page 900 may display the party’s selection of activity participants. In some embodiments, participants selection section 901 may include radio buttons associated with party member names for an escrow activity. The radio buttons may be highlighted to show the party’s selection.

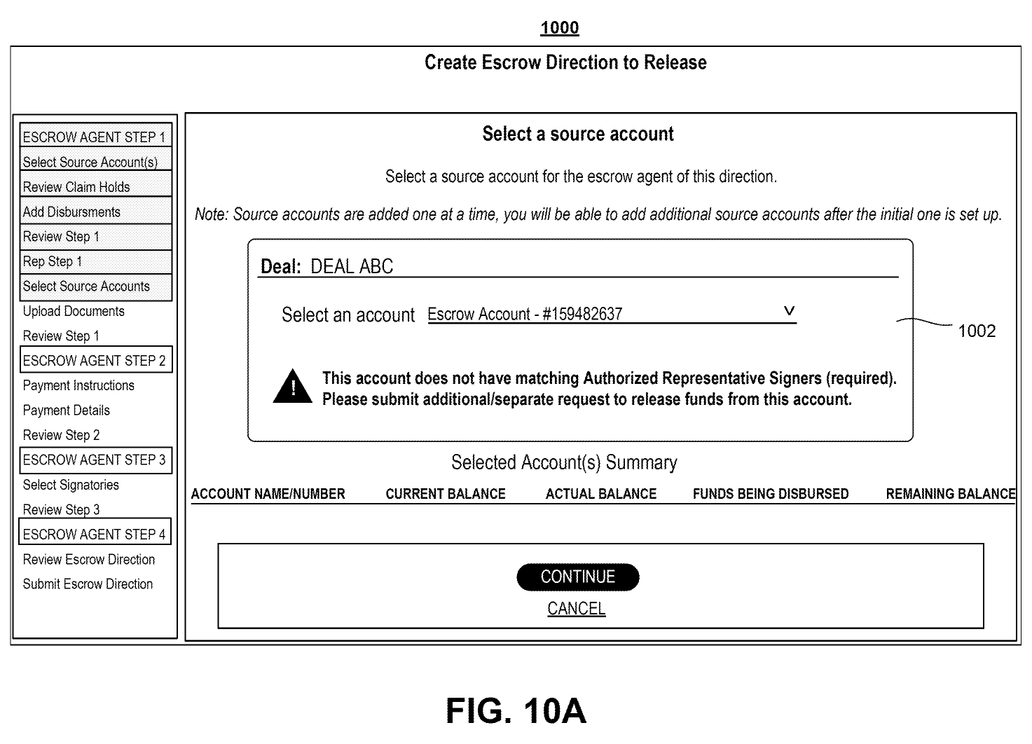

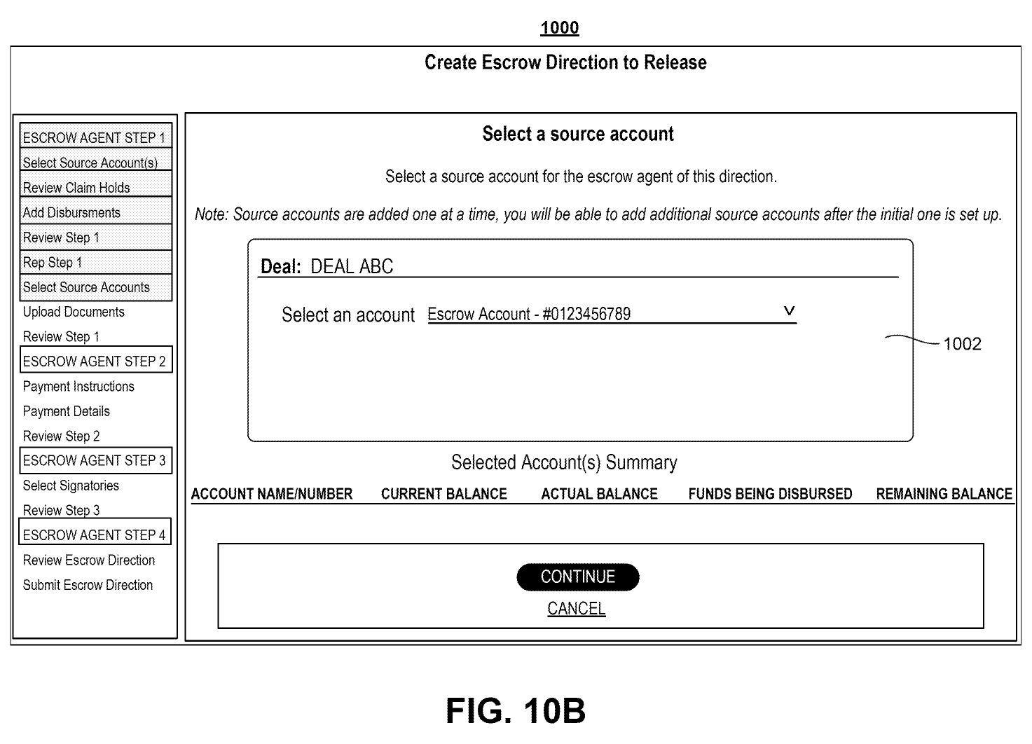

FIG. 10A is an exemplary display on a graphical user interface illustrating selecting a source account with missing information for an activity instruction, consistent with disclosed embodiments. When there is missing information, web page 1000 may display a warning message and block a party from advancing to the next step of setting up an activity instruction. In some embodiments, the “continue” button on the web page that leads to the next web page may be disabled. Web page 1000 may be accessed by a party to create a new activity instruction by selecting a source account identifier. The party may choose a source account in a source account selection section 1002 and submit the selection. In some embodiments, source account selection section 1002 may include a drop-down menu, listing existing escrow accounts for an escrow activity. A party initiating the activity may create a new escrow instruction by choosing an escrow account from the drop-down menu. In some embodiments, an escrow account may not have matching signatories, and a warning message may display in the account selection section.

FIG. 10B is an exemplary display on a graphical user interface illustrating selecting a source account for an activity, consistent with disclosed embodiments. In some embodiments, source account selection section 1002 may include a drop-down menu, listing existing escrow accounts for an escrow transaction. An existing escrow account may have met the requirements for the escrow activity and no warning message may display.

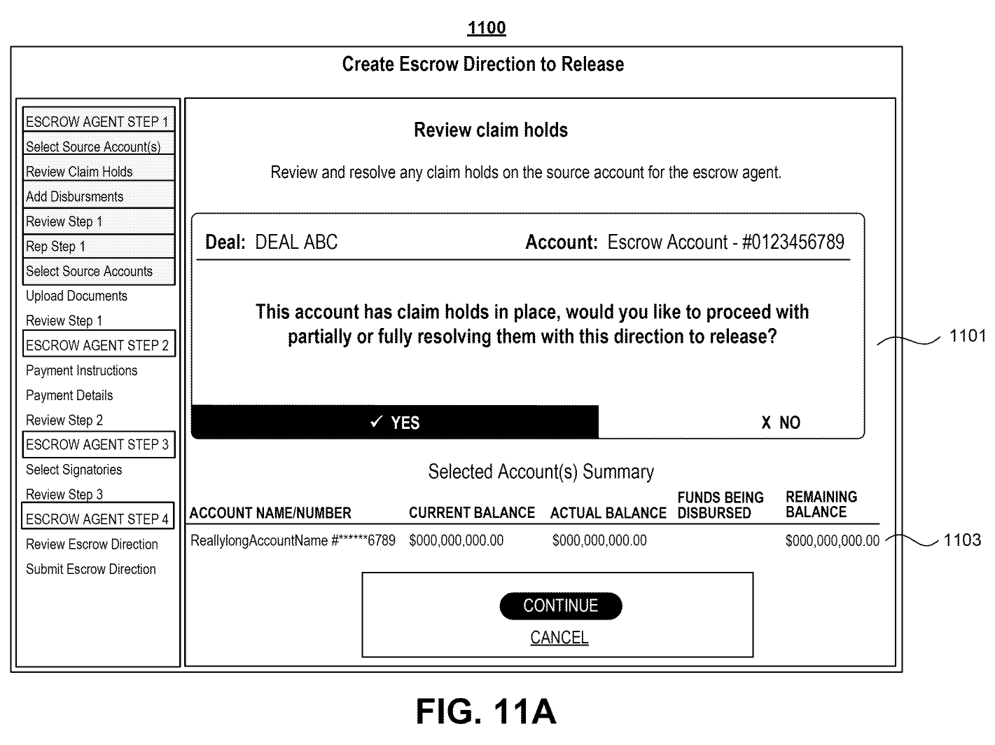

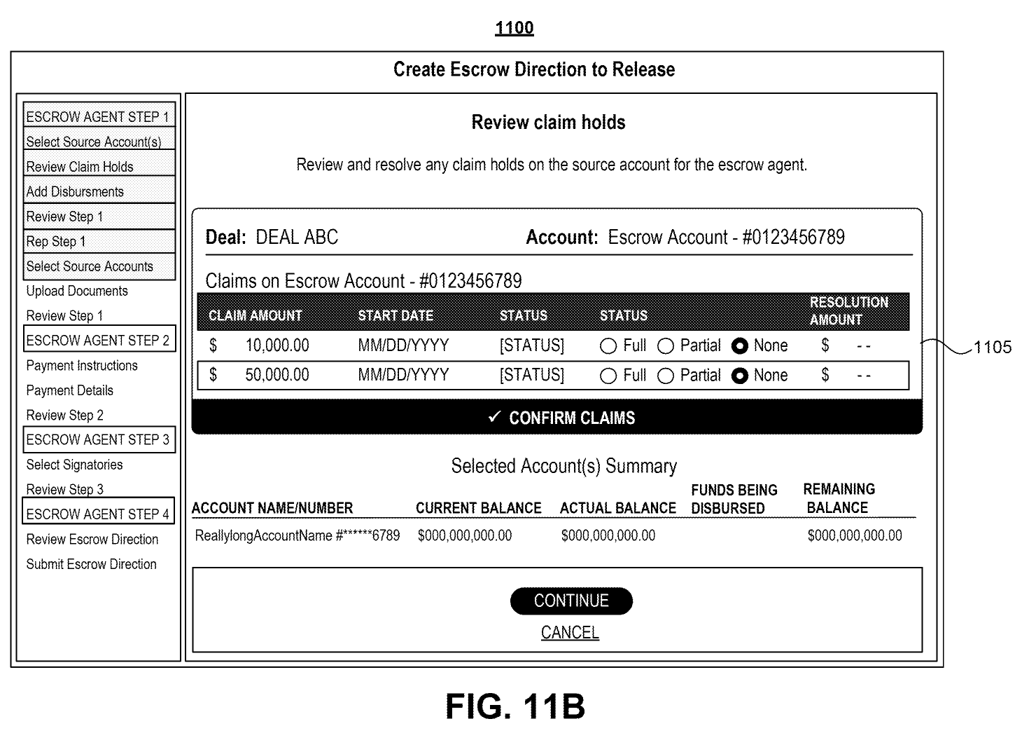

FIG. 11A is an exemplary display on a graphical user interface of resolving claim holds with a source account, consistent with disclosed embodiments. Web page 1100 may be displayed once a party selects a source account. Once the party makes the account selection, a selected account summary section 1103 may display the information related to the source account. If there is an unresolved claim related to the source account, a warning message 1101 may display to notify the party about the existence of the unresolved claim. In some embodiments, unresolved claims may create a claim hold on the source account, which may block a certain monetary amount from disbursement when processing a secure online transaction. In some embodiments, selected account summary section 1103 may include several columns. These columns may include an account name/number column, a current balance column, an actual balance column, a funds distribution column, and a remaining balance column. In some embodiments, warning message 1101 may give the party an option to proceed with partially or fully resolving claim holds.

FIG. 11B is an exemplary display on a graphical user interface presenting methods of claim hold resolution, consistent with disclosed embodiments. In some embodiments, when the party chooses to partially or fully resolve claim holds, methods for resolving claim holds may display. A claim hold resolution section 1105 may include buttons for resolving claim holds. In some embodiments, buttons for resolving claims holds may be buttons displaying “full, partial, or none.” The “full” button may allow a party to resolve a claim by paying the claim amount in full, the “partial” button may allow the party to pay the claim amount partially, and the party may ignore resolving the claim by selecting the “none” button. The buttons may be highlighted to show the party’s selection on how to proceed with resolving the claim holds. Claim hold resolution section 1105 may include several columns. These columns may include a claim amount column, a start date column, a status column, and a resolution amount column.

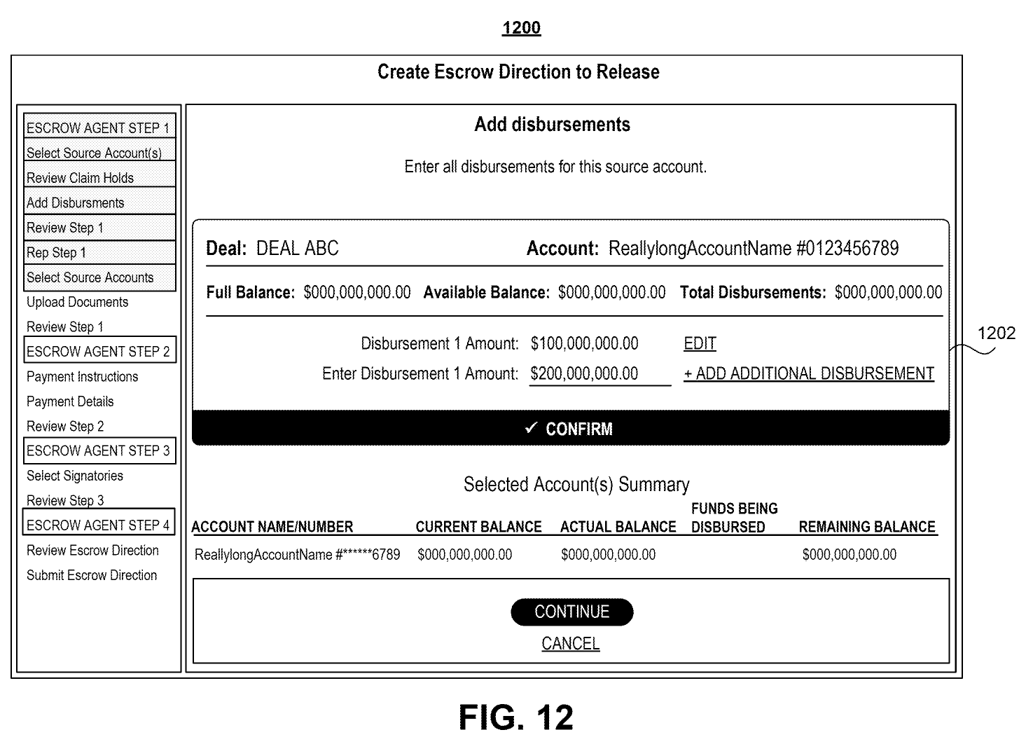

FIG. 12 is an exemplary display on a graphical user interface of setting up an activity instruction by adding distribution information, consistent with disclosed embodiments. Web page 1200 may be accessed by a party to create a new activity instruction by selecting or entering distribution parameters. The party may enter a distribution amount in a distribution section 1202 and submitting the selection. In some embodiments, distribution section 1202 may include user input field in which a party may enter a distribution amount for an escrow activity. The party may edit the distribution amount and/or enter additional distribution amount for multiple distributions.

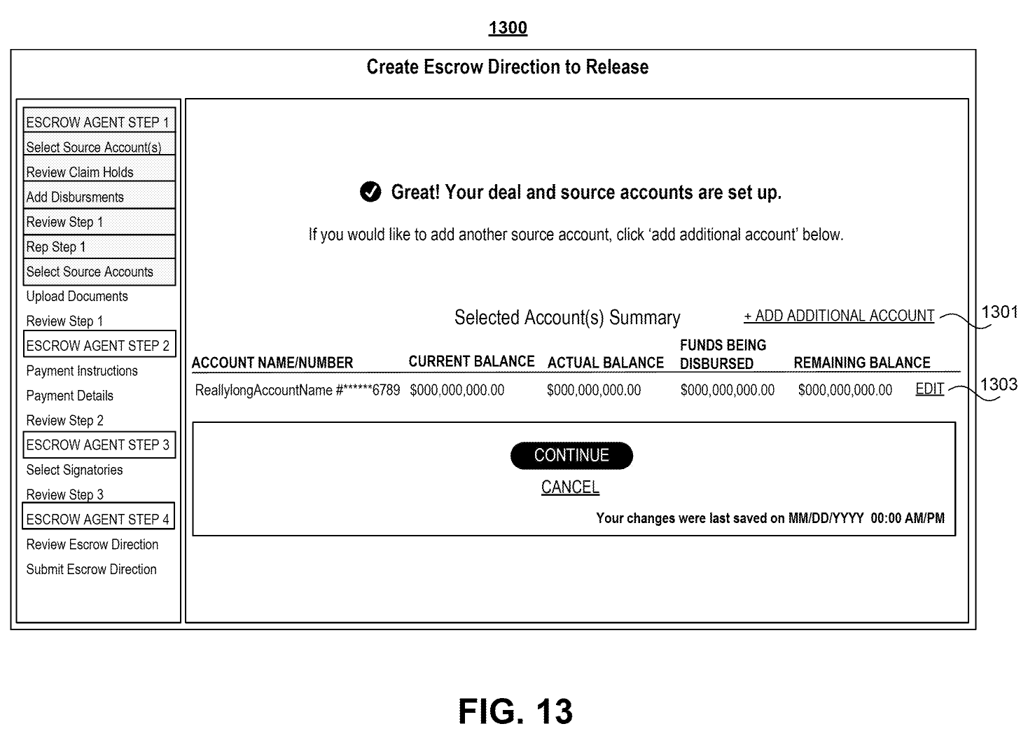

FIG. 13 is an exemplary display on a graphical user interface showing a confirmation message about the proper setup of activity identifier and source account, consistent with disclosed embodiments. Web page 1300 may display a confirmation message to the party, notifying the party that a part of an activity instruction is completed. The party may add additional source account(s) via add-account link 1301. The party may edit the source account that was set up earlier via edit link 1303. In some embodiments, a confirmation message may notify a party that the deal and source accounts are set up for an escrow transaction. In some embodiments, a confirmation message may be displayed on a confirmation web page or a modal.

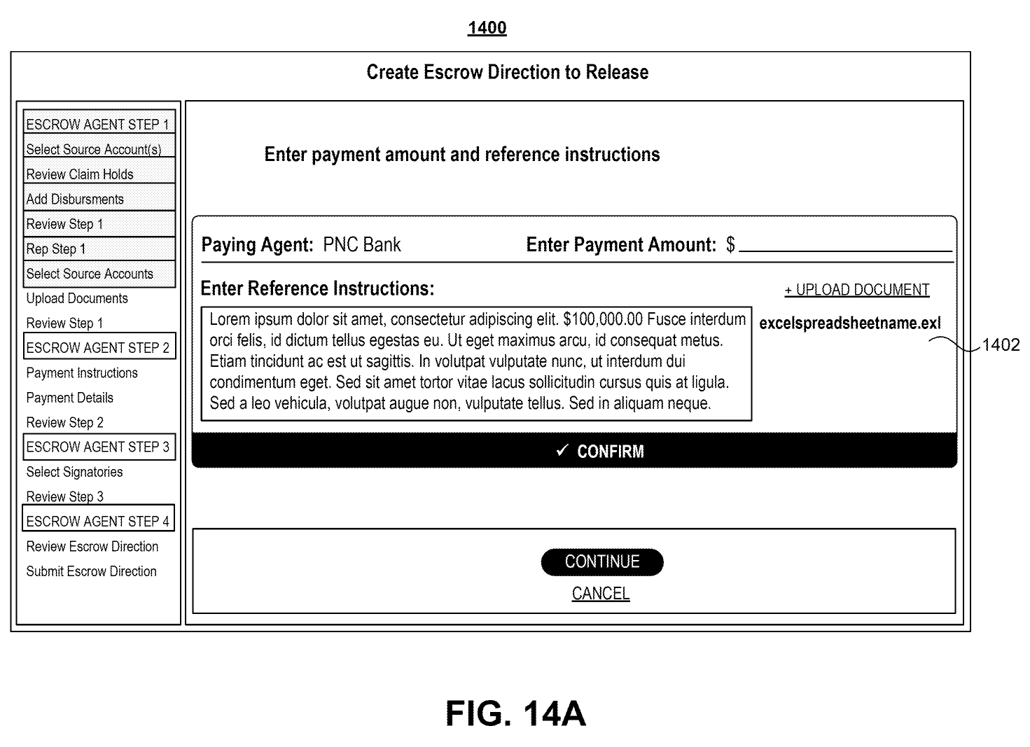

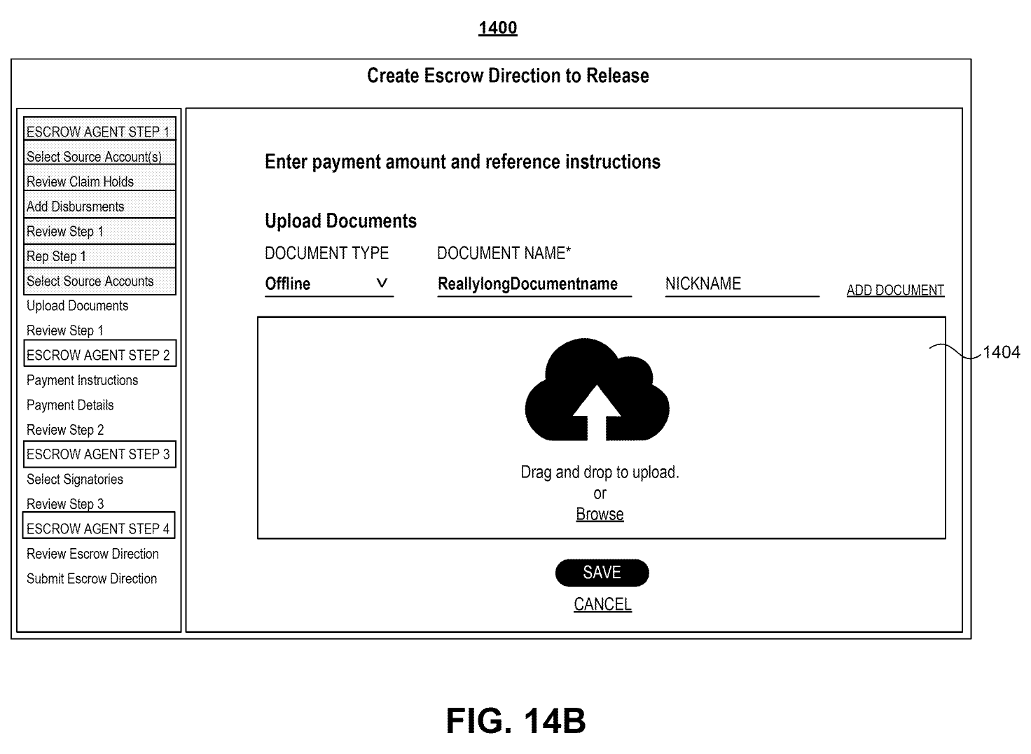

FIG. 14A is an exemplary display on a graphical user interface illustrating setting up a activity instruction by adding payment amount and reference instructions, consistent with disclosed embodiments. Web page 1400 may be accessed by a party to create a new activity instruction by entering payment amount and reference instructions. The party may enter payment amount in a payment section 1402. The party may enter or upload reference instructions in payment section 1402. In some embodiments, payment section 1402 may include user input field in which a party may enter a payment amount for an escrow activity. The party may enter reference instructions in user input field or upload a document containing reference instructions for the escrow activity in payment section 1402.

FIG. 14B is an exemplary display on a graphical user interface illustrating setting up an activity instruction by uploading documents regarding payment amount and reference instructions, consistent with disclosed embodiments. When a party chooses to upload a document containing payment amount and/or reference instructions from payment section 1402, web page 1400 may display user upload area 1404. In some embodiments, a party may upload new documents such as external files by dragging and dropping the documents or by browsing a local drive on party computing device to locate target documents.

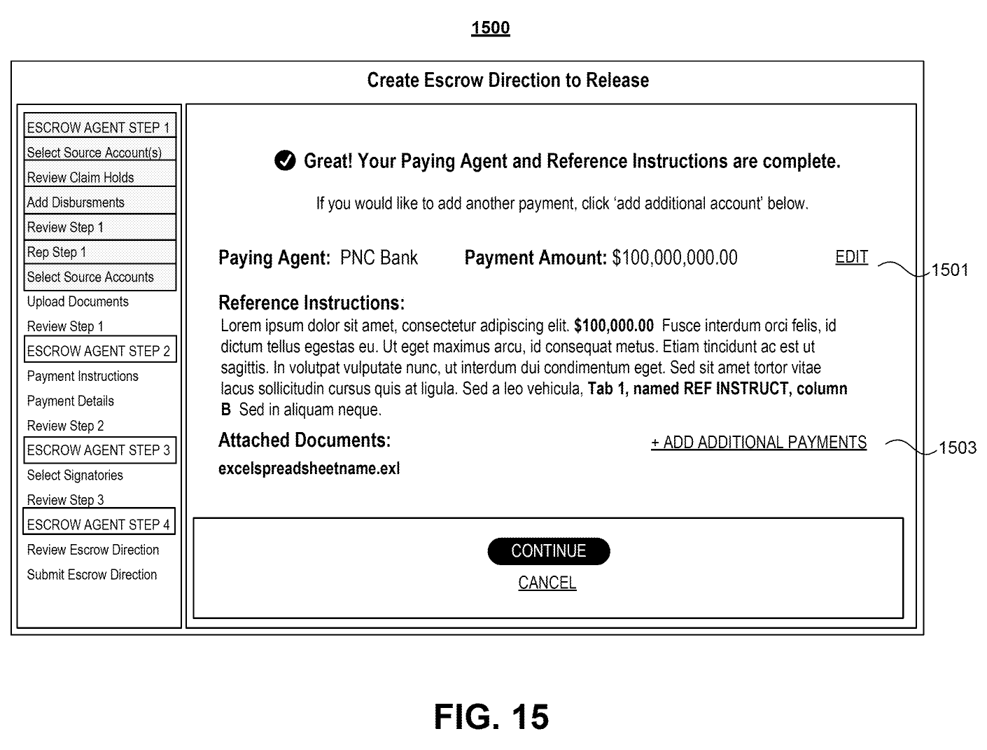

FIG. 15 is an exemplary display on a graphical user interface showing a confirmation message about the proper setup of payment amount and reference instructions, consistent with disclosed embodiments. Web page 1500 may display a confirmation message to the party, notifying that another part of an activity instruction is completed. The party may add additional payment(s) via add-payment link 1503. The party may edit the payment amount that was set up earlier, as shown in FIG. 14A, via edit link 1501. In some embodiments, a confirmation message may notify a party that paying agent and reference instructions are complete for an escrow activity. In some embodiments, a confirmation message may be displayed on a confirmation web page or a modal.

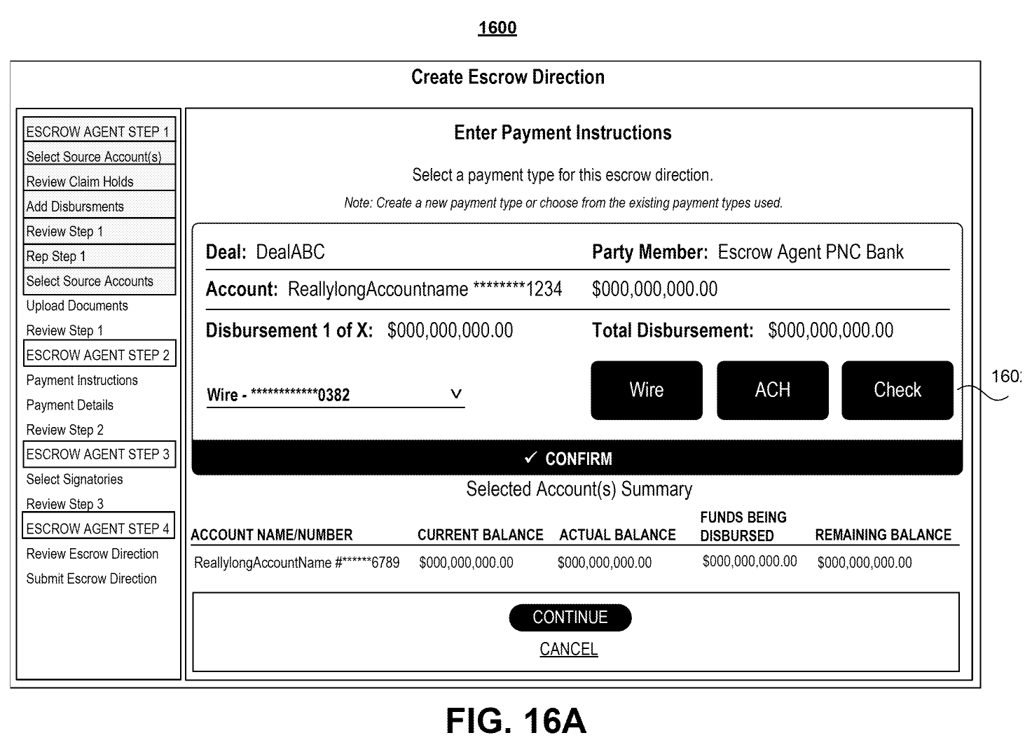

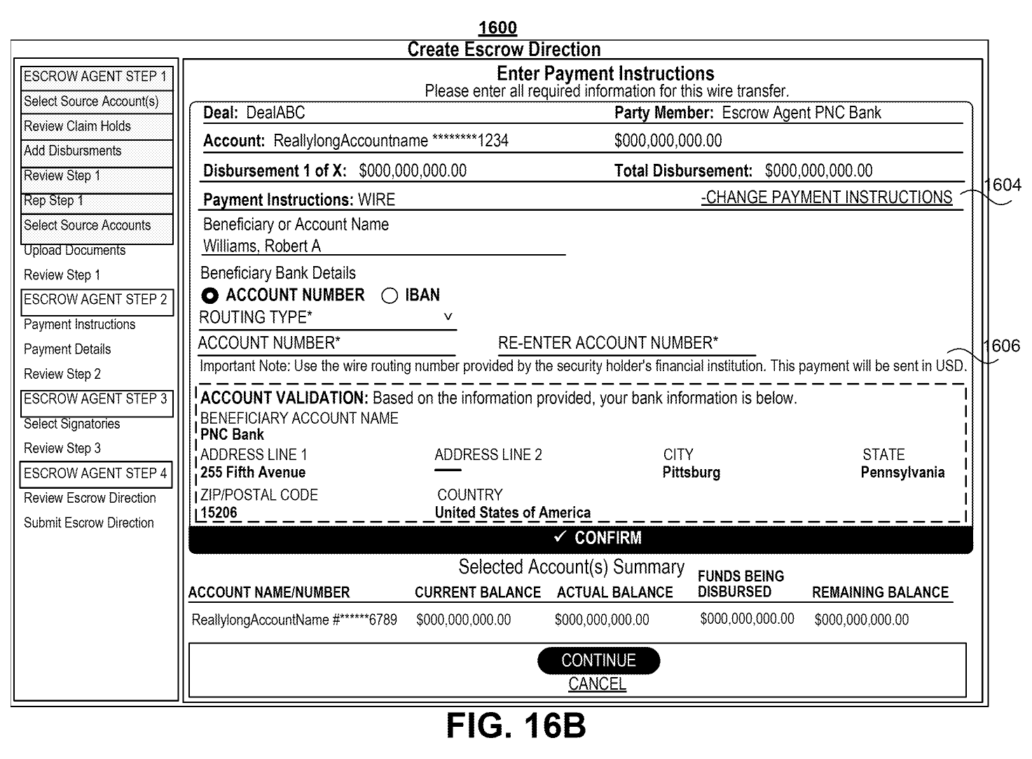

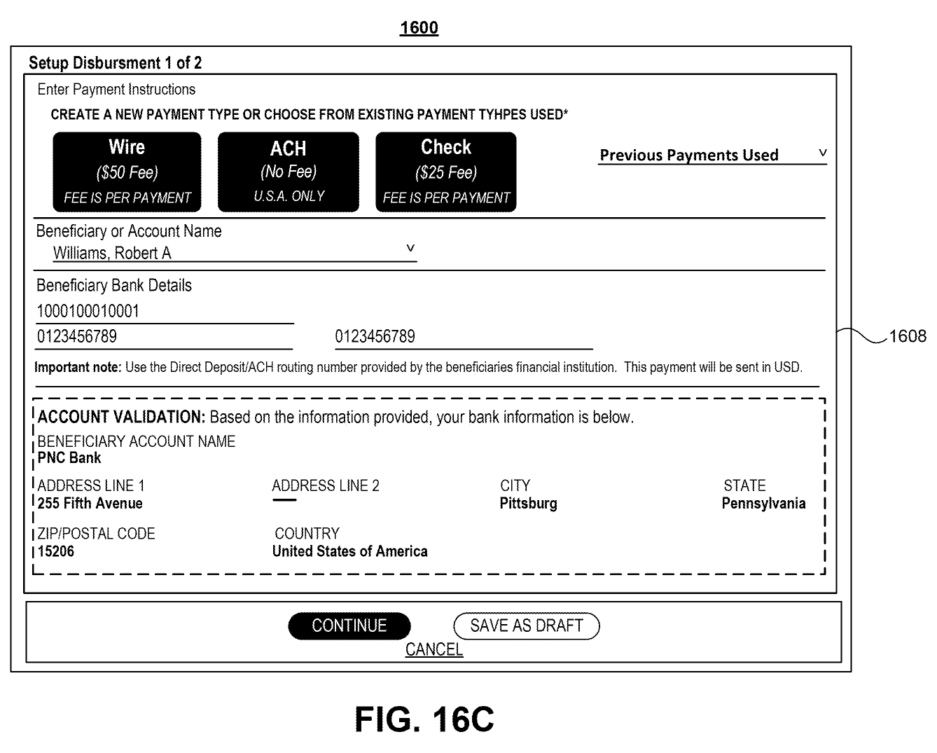

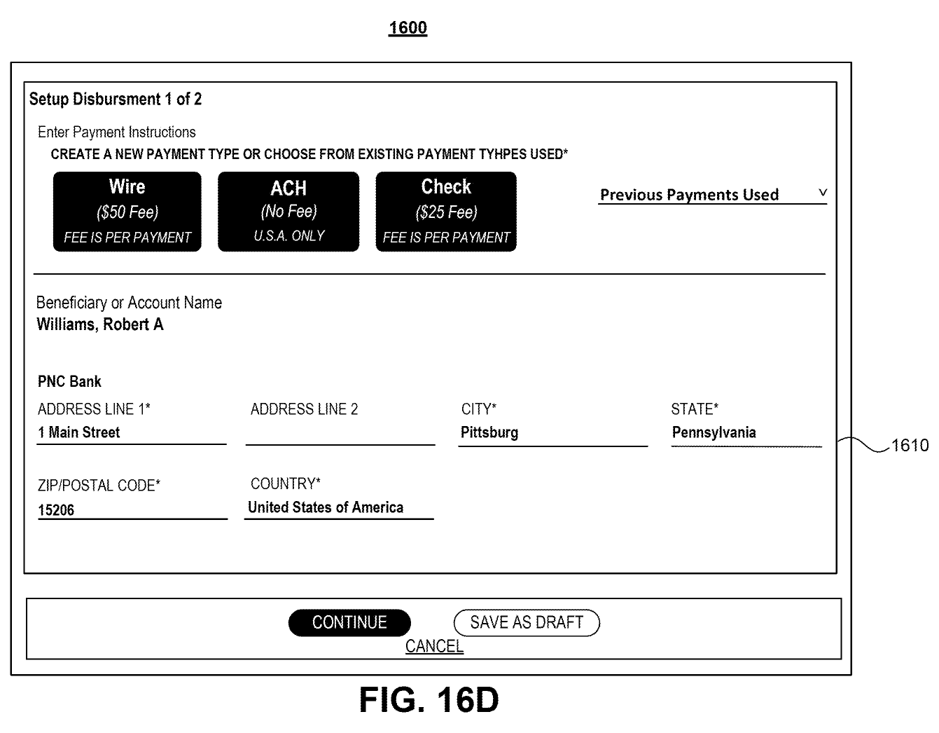

FIG. 16A is an exemplary display on a graphical user interface illustrating setting up an activity instruction by establishing payment instructions, consistent with disclosed embodiments. Web page 1600 may be accessed by a party to create a new activity instruction by establishing payment instructions. The party may choose a payment type in a payment method section 1602. In some embodiments, payment method section 1602 may include buttons that a party may choose from payment options (e.g., wire, ACH, check, etc.) for an escrow activity.

FIG. 16B is an exemplary display on a graphical user interface illustrating setting up an activity instruction by adding required information for a selected payment type, consistent with disclosed embodiments. Web page 1600 may display user input fields that need to be filled in by the party once a payment type is selected. The input fields in a beneficiary account information section 1606 may include a drop-down menu or entry fields where the party may type in information. The selected payment type may be changed via a change-payment link 1604. In some embodiments, when a wire transfer is selected for an escrow transaction, beneficiary bank details such as routing type and beneficiary account number may be required to be entered by a party to process the escrow activity. An account validation section, containing the beneficiary bank information, may display as a section of web page 1600.

FIG. 16C is an exemplary display on a graphical user interface illustrating setting up an activity instruction by adding required information for a selected payment type, consistent with disclosed embodiments. Web page 1600 may display different user input fields than those in FIG. 16B when a different payment type is selected. The different input fields in a beneficiary account information section 1608 may include a drop-down menu or other entry fields where the party may type in information. In some embodiments, when an ACH transfer is selected for an escrow activity, beneficiary bank details such as beneficiary routing number and account number may be required to be entered to process the escrow activity. An account validation section, containing the beneficiary bank information, may display as a section of web page 1600.

FIG. 16D is an exemplary display on a graphical user interface illustrating setting up an activity instruction by adding required information once a payment type is selected, consistent with disclosed embodiments. Web page 1600 may display different user input fields than those in FIG. 16B and FIG. 16C when a different payment type is selected. The different input fields in a beneficiary account information section 1610 may include a drop-down menu or other entry fields where the party may type in information. In some embodiments, when a check is selected for an escrow activity payment, beneficiary bank details such as beneficiary bank address may be required to be entered to process the escrow activity.

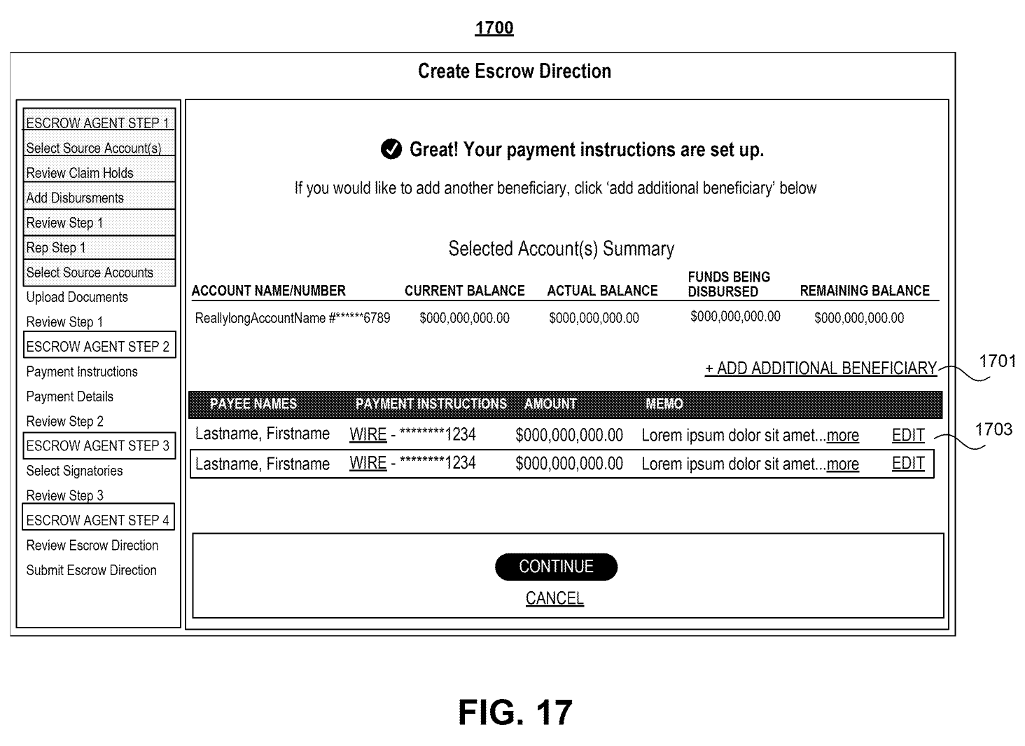

FIG. 17 is an exemplary display on a graphical user interface showing a confirmation message about the proper setup of payment instructions, consistent with disclosed embodiments. Web page 1700 may display a confirmation message to the party, notifying the party that a part of an activity instruction is completed. The party may add additional beneficiary via add-beneficiary link 1701. The party may edit the beneficiary payment information that was set up earlier as described in FIG. 16 via edit link 1703. In some embodiments, a confirmation message may notify a party that paying instructions are set up for an escrow activity. In some embodiments, a confirmation message may be displayed on a confirmation web page or a modal.

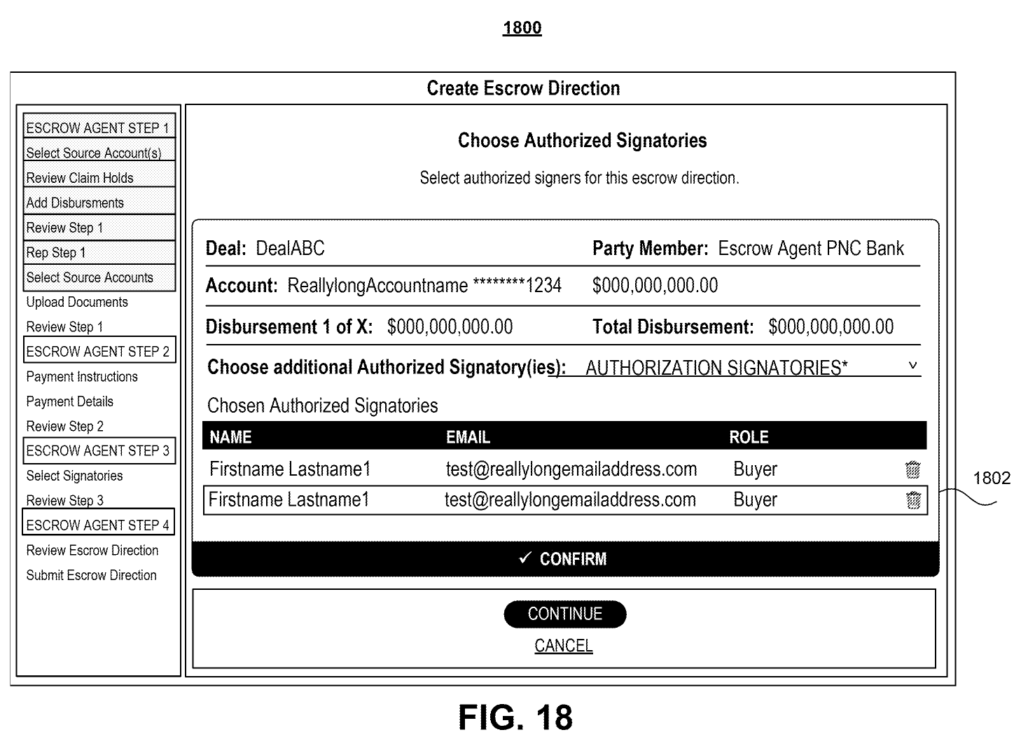

FIG. 18 is an exemplary display on a graphical user interface illustrating setting up an activity instruction by choosing authorized signatories, consistent with disclosed embodiments. Web page 1800 may be accessed by a party in the process of creating a new activity instruction. The party may choose a signatory in a signatory section 1802 and submit the selection. In some embodiments, signatory section 1802 may include a list of authorized signatories for an escrow activity. Signatory section 1802 may include several columns. These columns may include a name column, an email column, a role column, and a delete button that may remove a signatory.

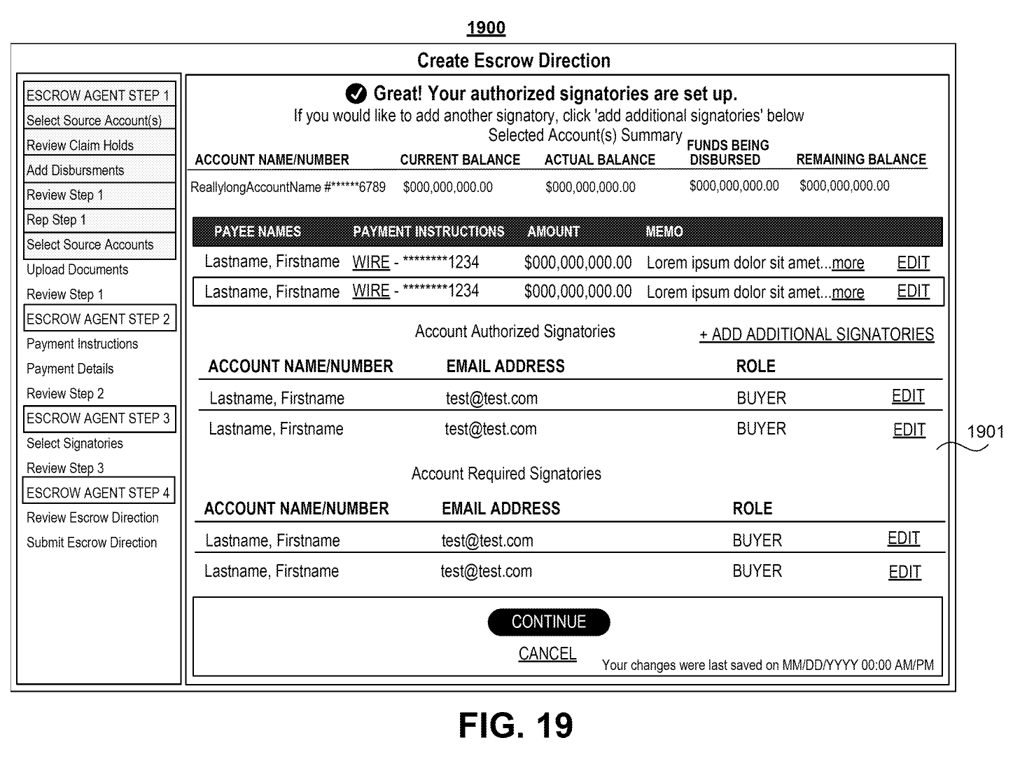

FIG. 19 is an exemplary display on a graphical user interface showing a confirmation message about the proper setup of authorized signatories, consistent with disclosed embodiments. Web page 1900 may display a confirmation message to the party, notifying that a part of an activity instruction is completed. The party may edit a signatory information that was set up earlier as described in FIG. 18 via edit link 1901. In some embodiments, a confirmation message may notify a party that authorized signatories are set up for an escrow activity. In some embodiments, a confirmation message may be displayed on a confirmation web page or a modal.

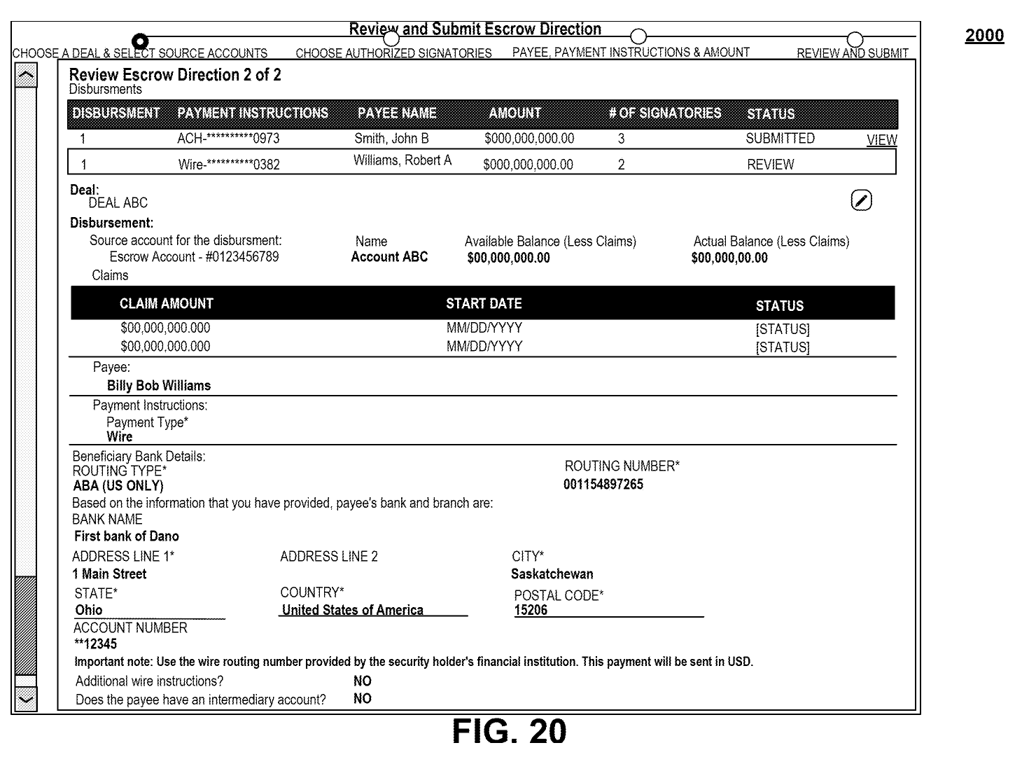

FIG. 20 is an exemplary display on a graphical user interface for reviewing an activity instruction prior to initiation of a secure online activity, consistent with disclosed embodiments. Web page 2000 may display an overview of all the information a party provided during a set up process of an activity instruction. The party may review the information before submitting the activity instruction to initiate a secure online activity. In some embodiments, an overview page of escrow instruction may display on web page 2000. The overview pages may include distribution information, payment information, beneficiary and beneficiary account information, and source account information.

As a whole, the disclosed systems and methods may provide improvements for handling activities online, including escrow agreements, because it allows participants involved in an online activity to exchange activity-related information in a more secure and efficient manner. Exchanges between the participants may occur through a central web application, rather than through multiple rounds of email exchanges. Using the central web application may reduce the risk of participants’ information being exposed to malicious actors or unintended third parties. The system’s structure and built-in mechanisms for verifying the status of an online activity may ensure better efficiency in handling the online activity compared to the conventional method of handling activities online based on email communication. A central repository that stores all documents exchanged in an online activity may reduce the time it takes to review and organize the documents to ensure compliance of the terms of the activity. An audit may be more efficiently conducted because it may take less time to collect, organize, and review all the documents from a single source, rather than from scattered sources throughout multiple emails. The graphical user interface presented herein may be more clearly organized without displaying a voluminous amount of data that a party, a counterparty, or an agent must review to determine whether an online activity should be processed and completed. This may be because a data set in the central repository may serve as a proxy for voluminous data scattered throughout multiple emails that may otherwise need to be processed by a processor. Instead, activity-related information may be consolidated and represented by the data set in the central repository. Therefore, instead of opening or running additional applications to determine whether the online activity should be processed and completed, a processor may only need to access the data set in a database, as described herein. The disclosed systems and methods may also provide a more secure and efficient way to handle sensitive activities such as escrow agreements and claim requests.

The disclosed embodiments are not limited to the above-described examples but instead are defined by the appended claims in light of their full scope of equivalents. Moreover, while illustrative embodiments have been described herein, the scope includes any and all embodiments having equivalent elements, modifications, omissions, combinations (e.g., of aspects across various embodiments), adaptations, or alterations based on the present disclosure. The elements in the claims are to be interpreted broadly based on the language employed in the claims and not limited to examples described in the present specification or during the prosecution of the application, which examples are to be construed as non-exclusive. Further, the steps of the disclosed methods maybe modified in any manner, including by reordering steps or inserting or deleting steps.

It is intended, therefore, that the specification and examples be considered as examples only, with a true scope and spirit being indicated by the following claims and their full scope of equivalents.

What is claimed is:

1. A method for enhancing data security and data transmission efficiency for online activities, the method being performed by at least one processor and comprising:
providing for display, on a graphical user interface:
at least one first section, wherein each first section is associated with an online activity identifier; and
a plurality of second sections, wherein each second section is associated with one of an activity data set;
receiving a data set for a plurality of parties, wherein the data set includes, for each of the plurality of parties, at least one of: a party identifier, an activity identifier associated with a party, a counterparty identifier, an activity source account identifier, a beneficiary account identifier, a party authorized signatory, or distribution parameters;
determining, for each of the plurality of parties, an activity instruction based on the received data set;
storing data from the data set and the activity instruction in a directory;
sending, upon a notification authorization, an alert notification to a counterparty about the activity instruction;
receiving an additional data set for the counterparty, wherein the additional data set includes at least one of: a counterparty identifier, a counterparty authorized signatory, or changes to the distribution parameters;
determining an additional activity instruction based on the received additional data set;
storing data from the additional data set and the additional activity instruction in the directory;
modifying the activity instruction by integrating the additional activity instruction;
receiving, for each activity identifier, an activity authorization associated with the activity identifier;
determining, for each activity identifier, an activity permission associated with the activity identifier; and
initiating an electronic resource distribution protocol based on the modified activity instruction.

2. The method of claim 1, further comprising displaying a plurality of lists, on a graphical user interface, the plurality of lists associated with at least one of: a party identifier, an activity identifier associated with a party, a counterparty identifier, an activity source account identifier, a beneficiary account identifier, a party authorized signatory, a counterparty signatory, distribution parameters, or any combination thereof.

3. The method of claim 1, further comprising automatically populating an activity instruction based on a previously received data set.

4. The method of claim 3, wherein the automatically populated activity instruction is based on at least one of: a party identifier, an activity identifier associated with a party, a counterparty identifier, an activity source account identifier, a beneficiary account identifier, a party authorized signatory, a counterparty signatory or distribution parameters.

5. The method of claim 3, further comprising modifying the automatically populated activity instruction when the party overwrites a data element in the previously received data set.

6. The method of claim 1, further comprising:
providing for display, on a graphical user interface, at least one file upload page or modal for the plurality of parties;
receiving external files, wherein the external files are associated with the data set for the plurality of parties; and
storing the external files in the directory.

7. The method of claim 1, further comprising:
providing for display, on a graphical user interface, at least one file upload page or modal for the counterparty;
receiving external files, wherein the external files are associated with the additional data set for the counterparty; and
storing the external files in the directory.

8. The method of claim 1, wherein the notification authorization is initially set to not authorized status.

9. The method of claim 8, further comprising updating the notification to authorized status.

10. The method of claim 1, wherein the alert notification is delivered via at least one of a short message service text notification, an application push notification, an email notification, or any combination thereof.

11. The method of claim 1, further comprising:
providing for display, on a graphical user interface, a confirmation page or modal;
displaying the received data set associated with activity identifier and source account data; and
receiving, via the confirmation page or modal, the party input to modify the data set or to confirm the data set to be proper.

12. The method of claim 1, further comprising:
providing for display, on a graphical user interface, a confirmation page or modal;
displaying the received data set associated with activity identifier, a first value amount and reference instructions data; and
receiving, via the confirmation page or modal, the party input to modify the data set or to confirm the data set to be proper.

13. The method of claim 1, further comprising:
providing for display, on a graphical user interface, a confirmation page or modal;
displaying the received data set associated with activity identifier and transfer instructions data; and
receiving, via the confirmation page or modal, the party input to modify the data set or to confirm the data set to be proper.

14. The method of claim 13, wherein the transfer instructions data include transfer method options.

15. The method of claim 1, further comprising:
providing for display, on a graphical user interface, a confirmation page or modal;
displaying the received data set associated with activity identifier and party authorized signatory data; and
receiving, via the confirmation page or modal, the party input to modify the data set or to confirm the data set to be proper.

16. The method of claim 1, further comprising:
providing for display, on a graphical user interface, a confirmation page;
displaying the summary of received data set associated the activity instruction; and
receiving, via the confirmation page, the party input to modify the data set or to submit the data set.

17. The method of claim 1, wherein determining the activity permission based on the activity authorization, the activity instruction, the data set and the additional data set further comprises: setting the activity permission to permitted if there is no missing requisite data.

18. The method of claim 1, further comprising blocking a certain value amount from the electronic resource distribution protocol if an unresolved claim associated with the source account identifier exists prior to the electronic resource distribution protocol.

19. A non-transitory computer readable medium storing instructions that, when executed by at least one processor, cause the at least one processor to perform operations for enhancing data security and data transmission efficiency for secure online activities, the operations comprising:
providing for display, on a graphical user interface:
at least one first section, wherein each first section is associated with an online activity identifier; and
a plurality of second sections, wherein each second section is associated with one of an activity data set;
receiving a data set for a plurality of parties, wherein the data set includes, for each of the plurality of parties, at least one of: a party identifier, an activity identifier associated with a party, a counterparty identifier, an activity source account identifier, a beneficiary account identifier, a party authorized signatory, or distribution parameters;
determining, for each of the plurality of parties, an activity instruction based on the received data set;
storing data from the data set and the activity instruction in a directory;
sending, upon a notification authorization, an alert notification to a counterparty about the activity instruction;
receiving an additional data set for the counterparty, wherein the additional data set includes at least one of: a counterparty identifier, a counterparty authorized signatory, or changes to the distribution parameters;
determining an additional activity instruction based on the received additional data set;
storing data from the additional date set and the additional activity instruction in the directory;
modifying the activity instruction by integrating the additional activity instruction;
receiving, for each activity identifier, an activity authorization associated with the activity identifier;
determining, for each activity identifier, an activity permission associated with the activity identifier; and
initiating an electronic resource distribution protocol based on the modified activity instruction.

20. A system for enhancing data security and data transmission efficiency for secure online activities, comprising:
a memory storing instructions; and
at least one processor configured to execute the instructions to:
provide for display, on a graphical user interface:
at least one first section, wherein each first section is associated with an online activity identifier; and
a plurality of second sections, wherein each second section is associated with one of an activity data set;
receive a data set for a plurality of parties, wherein the data set includes, for each of the plurality of parties, at least one of: a party identifier, an activity identifier associated with a party, a counterparty identifier, an activity source account identifier, a beneficiary account identifier, a party authorized signatory, or distribution parameters;
determine, for each of the plurality of parties, an activity instruction based on the received data set;
store data from the data set and the activity instruction in a directory;
send, upon a notification authorization, an alert notification to a counterparty about the activity instruction;
receive an additional data set for the counterparty, wherein the additional data set includes at least one of: a counterparty identifier, a counterparty authorized signatory, or changes to the distribution parameters;
determine an additional activity instruction based on the received additional data set;
store data from the additional date set and the additional activity instruction in the directory;
modify the activity instruction by integrating the additional activity instruction;
receive, for each activity identifier, an activity authorization associated with the activity identifier;
determine, for each activity identifier, an activity permission associated with the activity identifier; and
initiate an electronic resource distribution protocol based on the modified activity instruction.
